(19) United States
(12) Patent Application Publication
(10) Pub. No.: US 2011/0095227 A1
(43) Pub. Date: Apr. 28, 2011

(54) RETARDED SUPERABSORBENT POLYMERS

(76) Inventors: Gregor Herth, Trostberg (DE); Michael Schinabeck, Altenmarkt (DE); Stefan Friedrich, Garching (DE)

(21) Appl. No.: 12/994,201

(22) PCT Filed: May 15, 2009
(86) PCT No.: PCT/EP2009/055907

§ 371 Date: Dec. 14, 2010

(30) Foreign Application Priority Data
Jun. 27, 2008 (DE) 10 2008 030 712.2

(51) Int. Cl. B01J 20/26; C08F 228/02; C08F 220/56; C08J 3/28

(52) U.S. Cl. 252/194; 526/287; 526/307.3; 522/152; 521/149

(57) ABSTRACT

What is claimed is a superabsorbent polymer (SAP) with anionic and/or cationic properties and retarded swelling action, which was prepared by polymerizing ethylenically unsaturated vinyl compounds. This SAP is characterized in that its swelling begins no earlier than after 5 minutes and in that it was prepared with the aid of at least one process variant selected from the group of
a) polymerizing the monomer components in the presence of a combination consisting of at least one hydrolysis-stable crosslinker and at least one hydrolysis-labile crosslinker;
b) polymerizing at least one permanently anionic monomer and at least one hydrolysable cationic monomer;
c) coating a core polymer component with at least one further polyelectrolyte as a shell polymer;
d) polymerizing at least one hydrolysis-stable monomer with at least one hydrolysis-labile monomer in the presence of at least one crosslinker.

Owing to the variability of the three preparation alternatives with regard to the starting materials and the process conditions, but also owing to the possible combinations with one another, the present invention can provide superabsorbent polymers which are suitable especially for use in foams, mouldings and fibres, but also as carriers for plant growth- and fungal growth-regulating agents, and for controlled release of active ingredients, or in construction materials. The present polymers are suitable especially for use as construction material additives.

The present invention relates to a superabsorbent polymer with retarded swelling and to the use thereof.

Superabsorbent polymers are crosslinked, high molecular weight, either anionic or cationic polyelectrolytes which are obtainable by free-radical polymerization of suitable ethylenically unsaturated vinyl compounds and subsequent measures for drying the resulting copolymers. On contact with water or aqueous systems, a hydrogel forms with swelling and water absorption, in which case several times the weight of the pulverulent copolymer can be absorbed. Hydrogels are understood to mean water-containing gels based on hydrophilic but crosslinked water-insoluble polymers which are present in the form of three-dimensional networks.

Superabsorbent polymers are thus generally crosslinked polyelectrolytes, for example consisting of partly neutralized polyacrylic acid. They are described in detail in the book “Modern Superabsorbent Polymer Technology” (F. L. Buchholz and A. T. Graham, Wiley-VCH, 1998). In addition, more recent patent literature includes a multitude of patents which are concerned with superabsorbent polymers.

In recent times, superabsorbent polymers have also been developed for use in construction material mixtures which have very good action at high salt concentrations, as caused, for example, by the addition of calcium formate as an accelerant.

“R. Bayer, H. Lutz, Dry Mortars, Ullmann's Encyclopedia of Industrial Chemistry, 6th ed., vol. 11, Wiley-VCH, Weinheim, (2003), 83-108” gives an overview of the applications and the composition of dry mortars.

Both the superabsorbent polymers described in Buchholz and those described in later patent applications are so-called “fast” products, i.e. they achieve their full water absorption capacity within a few minutes. In the case of use in hygiene articles in particular, it is necessary that liquids are absorbed as rapidly as possible in order thus to prevent them from running out of the hygiene article. For applications in other application sectors, for example the construction chemicals sector and especially in dry mortars and concrete, this means, however, that the full absorption capacity of the superabsorbent polymer is attained as early as during the mixing phase (mixing of the dry mortar into water); the mixing water is therefore no longer available for adjusting the consistency (rheology). There are some applications of dry mortars (for example as jointing mortar) or concretes (manufacture of precast concrete components), in which, after they have been introduced into the joint or into the mould of the precast component, a steep rise in the viscosity is desired (referred to hereinafter as rheology jump). The jointing mortar should be easy to introduce into the joint, while it should ultimately be stiff and dimensionally stable in the joint. A concrete for the precast components industry should be easy to introduce into the mould, but then very rapidly have a firm consistency, in order that it is possible to demould speedily. It is generally the case that the viscosity of a construction material mixed with water depends on the water content of the cement matrix. This is described by the water/cement value. The higher this value is, the lower is the viscosity of the construction material. With regard to the hydrogels already mentioned, it is the case that the hydrogel formed from the pulverulent, superabsorbent copolymer by water absorption should have a very low level of water-soluble constituents in order not to adversely affect the rheology properties of the construction material mixtures.

A further problem in construction material mixtures is bleeding, which sets in with time; i.e. water separates from the mixed construction material mixture, accumulates at the surface and floats on top. This bleeding is generally undesired, since it likewise removes the mixing water required for the hydration from the construction material mixture. In many applications, the evaporated water leaves behind an unappealing salt crust, which is generally undesired.

For applications of dry mortars, for example jointing mortars and levelling materials for floors, an accelerated setting process is likewise desirable. During the processing in the joint or on the floor, a low viscosity is desired, which should then rise rapidly in the joint in order that the shape is maintained. The sooner this is the case, the sooner the tiles laid can be washed without washing out the joint again. This would constitute a considerable benefit for the user, since mortar residues could be removed more easily from the joints without leaving behind cement streaks or attacking the surface of the tile.

To date, this processing profile has been established by means of a mixture of Portland cement (PC) and alumina cement (AC). Although it is possible in this way to establish the desired rheology profile, other difficulties occur. Generally, a PC/AC formulation is more difficult to establish and less reliable than a pure PC formulation, i.e. raw material variations or slight deviations in the composition have major effects. In most PC/AC formulations, it is additionally necessary to add Li₂CO₃, which is a significant cost driver for these products. A further major problem in application is the low storage stability. Specifically, in the course of storage, a shift in the rheology profile occurs, which is understandably undesired.

DE 10315270 A1 describes a surface treatment of the alumina cement with a polymer compound. This ensures retarded hardening of the alumina cement. The intention of this is to achieve a stable consistency during the processing time, but for rapid solidification to set in after the processing. However, it is still an alumina cement system with the above-described disadvantages.

Generally, it can be stated that formulators of dry mortars prefer pure PC systems, and so superabsorbent polymers with a very retarded swelling action may constitute an important component of future formulations.

For levelling materials, the early strength discussed above is economically very important. The higher the early strength, the more rapidly the further layers can be applied to the floor. However, a minimum level of mixing water is needed to achieve the necessary free flow of a levelling material. This is difficult to combine with the desired early strength, since this, as described above, is dependent on the w/c value. Therefore, a concentration of the pore solution after application would also be desired here. A problem which frequently occurs in practice here too is the above-described bleeding. This often occurs in the first few hours after processing. The water on the surface evaporates and leaves behind an unappealing surface appearance (crust formation).

In the precast concrete components industry, there is currently high cost pressure. A significant component of the cost structure is the residence time in the mould. The more quickly the precast component can be taken from the mould, the less expensive is the production. It is obvious that this can only be done once the moulding has a certain stability. To fill the mould, a very low viscosity is required, whereas a relatively high viscosity of the concrete is desired subsequently in the mould. What would thus be ideal would be a rheology jump of the unset construction material mixture in the mould. The consistency of a concrete for the precast components industry again depends on the water-cement value (w/c value); the higher the w/c value, the lower the viscosity. In addition, the consistency is adjusted by the use of plasticizers.

Reference is made by way of example at this point to the following patent documents:

U.S. Pat. No. 5,837,789 describes a crosslinked polymer which is used for absorption of aqueous liquids. This polymer is formed from partly neutralized monomers with monoethylenically unsaturated acid groups and optionally further monomers which are copolymerized with the first component groups. A process for preparing these polymers is also described, wherein the particular starting components are first polymerized to a hydrogel with the aid of solution or suspension polymerization. The polymer thus obtained can subsequently be crosslinked on its surface, which should preferably be done at elevated temperatures.

Gel particles with superabsorbent properties, which are composed of a plurality of components, are described in U.S. Pat. No. 6,603,056 B2. The gel particles comprise at least one resin which is capable of absorbing acidic, aqueous solutions, and at least one resin which can absorb basic, aqueous solutions. Each particle also comprises at least one microdomain of the acidic resin, which is in immediate contact with a microdomain of the basic resin. The superabsorbent polymer thus obtained is notable for a defined conductivity in salt solutions, and also for a defined absorption capacity under pressure conditions.

The emphasis of EP 1 393 757 B1 is on absorbent cores for nappies with reduced thickness. The absorbent cores for capturing body fluids comprise particles which are capable of forming superabsorbent cores. Some of the particles are provided with surface crosslinking in order to impart an individual stability to the particles, so as to give rise to a defined salt flow conductivity. The surface layer is bonded essentially noncovalently to the particles and it contains a partly hydrolysable, cationic polymer which is hydrolysed within the range from 40 to 80%. This layer has to be applied to the particles in an amount of less than 10% by weight. The partly hydrolysed polymer is preferably a variant based on N-vinylalkylamide or N-vinyl alkylamide, and especially on N-vinylformamide.

Superabsorbent hydrogels coated with crosslinked polyamines are also described in International Patent Application WO 03/0436701 A1. The shell comprises cationic polymers which have been crosslinked by an addition reaction, The hydrogel-forming polymer thus obtainable has a residual water content of less than 10% by weight.

A water-absorbing polymer structure surface-treated with polycations is described in German Offenlegungsschrift DE 10 2005 018 922 A1. This polymer structure, which has also been contacted with at least one anion, has an absorption under a pressure of 50 g/m² of at least 16 g/g.

Superabsorbent polymers coated with a polyamine are the subject matter of WO 2006/082188 A1. Such superabsorbent polymer particles are based on a polymer with a pH of >6, The hygiene articles which have also been described in this connection exhibit a fast absorption rate with respect to body fluids.

Superabsorbent polymer particles coated with polyamines are also disclosed by WO 2006/082189 A1. A typical polyamine compound mentioned here is polyammonium carbonate. In this case too, the fast absorption of body fluids by the particles is at the forefront.

A typical preparation process for polymers and copolymers of water-soluble monomers and especially of acrylic acid and methacrylic acid is disclosed in U.S. Pat. No. 4,857,610. Aqueous solutions of the particular monomers which contain polymerizable double bonds are subjected at temperatures between −10 and 120° C. to a polymerization reaction so as to give rise to a polymer layer of thickness at least one centimetre. These polymers obtainable in this way also possess fast superabsorbent properties.

A construction material composition with retarded action is disclosed in German Offenlegungsschrift DE 103 15 270 A1. This composition comprises, as well as a reactive carrier material, a liquid polymer compound applied thereto. The carrier materials mentioned are hydraulic and latent hydraulic binders, but also inorganic additives and/or organic compounds. Typical polymer compounds are polyvinyl alcohols, polyvinyl acetates and polymers based on 2-acrylamido-2-methylpropanesulphonic acid (AMPS). The time-dependent detachment of the polymer component from the carrier material causes retarded release in the construction chemical blend made up with water. This is associated with this is time-controlled setting of the hydratable construction material mixtures, which also enables time-controlled “inner drying” of the water-based construction materials.

Finally, US 2006/0054056 A1 describes a process for producing concrete products with a reduced tendency to efflorescence. In this connection, water-absorbent polymers find a specific use. These absorbent components are added to the concrete mixture in powder form, as a liquid or as a granule. In connection with the water-absorbing components, especially organic thickeners, for example cellulose and derivatives thereof, but also polyvinyl alcohol and polyacrylamides, and also polyethylene oxides, are mentioned. However, useful thickeners are also starch-modified superabsorbent polyacrylates and insoluble, water-swellable and crosslinked cellulose ethers, and additionally sulphonated monovinylidene polymers, Mannich acrylamide polymers and polydimethyldiallylammonium salts.

It was an object of the present invention, especially for construction applications, to develop a system and/or product which—for example after the introduction of the mixed construction material at its intended site—brings about a rheology jump in the construction material or absorbs bleeding water which occurs there, such that there is no phase demixing and/or separation of the construction material. It is also desirable to provide a system which is capable of absorbing any bleeding water which forms.

A technical problem which can be derived from this is especially that of providing an admixture to dry mortars (cement- or gypsum-based) and to concretes, which enables, after a defined time, the w/c value in the pore solution of the setting construction material mixture or of the concrete to be altered such that no bleeding occurs and/or a rheology jump in the sense of a significant increase in the viscosity is achieved. This assumes that water stored in the particular superabsorbent polymer is not part of the pore solution but is available to the hydration reaction: as soon as a water deficiency occurs in the pore solution, water should be able to migrate from the superabsorbent polymer into the pore solution.

For this purpose, the provision of a suitable superabsorbent polymer (SAP) with the aid of corresponding preparation processes was at the forefront, The SAP was to be a polymer with anionic and/or cationic properties and a retarded swelling action; it was to be prepared by polymerizing ethylenically unsaturated vinyl compounds.

This object is achieved by a superabsorbent polymer (SAP), which is characterized in that its swelling begins no earlier than after 5 minutes and in that it was prepared with the aid of at least one process variant selected from the group of
a) polymerizing the monomer components in the presence of a combination consisting of at least one hydrolysis-stable crosslinker and at least one hydrolysis-labile crosslinker;
b) polymerizing at least one permanently anionic monomer and at least one hydrolysable cationic monomer;
c) coating a core polymer component with at least one further polyelectrolyte as a shell polymer;
d) polymerizing at least one hydrolysis-stable monomer with at least one hydrolysis-labile monomer in the presence of at least one crosslinker.

It has been found that, surprisingly, the rheology jump desired according to the objective is indeed achieved as a result of the water absorption into the inventive superabsorbent polymers. Specifically, these SAPs absorb liquid from the pore solution only after a particular time, for example after 30 minutes, which is manifested in a steep rise in the viscosity. A measure employed for the viscosity of the concrete is the slump. However, when the inventive superabsorbent polymers are employed, yet a further advantage is found: the concentration of the pore solution accelerates the setting operation, i.e. the hydration of the cement clinker. This achieves higher early strengths, which likewise makes an important contribution to short mould times. Since the retarded superabsorbent polymer forms an inert water reservoir, the w/c ratio, which is relevant for the setting and thus for the final strength, is lower. This leads to a higher final strength and hence to an improved durability.

The application of the inventive polymers is, however, surprisingly restricted not just to construction material systems. Many applications in which water absorption is necessary after a defined time are possible, particularly those applications in which a solid end product is formed from a solution, emulsion or suspension. The present invention takes account of this idea through the different inventive use variants.

According to the present invention, advantageous superabsorbents are in particular those which, even at moderate to higher salt concentrations, especially high calcium ion concentrations, have a high water absorption capacity. According to the invention, the expression “retarded swelling action” shall be understood to mean the fact that the SAP begins to swell, i.e. the liquid absorption begins, no earlier than after 5 minutes, According to the invention, “retarded” means that, in particular, the predominant portion of the swelling of the superabsorbent polymer occurs only after more than 10 minutes, preferably after more than 15 min and more preferably only after more than 30 minutes. In connection with hygiene articles, delay in the range of a few seconds has already been known for a long time, in order that, for example, the liquid is first distributed within the nappy before it is absorbed in order to be able to exploit the entire amount of superabsorbent in the nappy and to require less nonwoven material. In the present case of the invention, however, retardation is understood to mean longer periods of more than 5 minutes and especially more than 10 minutes.

The superabsorbent polymers retarded in accordance with the invention are provided in four embodiments:

Polymerization with involvement of a
a) combination of a hydrolysis-stable crosslinker and of a hydrolysis-labile crosslinker; or/and
b) polymerization of a permanently anionic monomer and a hydrolysable cationic monomer; or/and
c) coating of a superabsorbent polymer as a core with a further polyelectrolyte as a shell, said core copolymer comprising hydrolysis-stable crosslinkers; or/and
d) polymerization of at least one hydrolysis-stable monomer with at least one hydrolysis-labile monomer in the presence of at least one crosslinker.

Each of embodiments a), b), c) or d) can be used alone. This is referred to hereinafter as “pure embodiment”. However, it is also possible to combine the inventive embodiments with one another. For instance, a polymer according to embodiment a) can be coated with a further polyelectrolyte in an additional process step according to embodiment c), in order to establish the retardation even more exactly. This is referred to hereinafter as “mixed embodiments”. What is common to all embodiments, whether pure or mixed, is that the properties of the resulting retarded superabsorbent polymer correspond to the profile of requirements. In each of the embodiments, the introduction of the inventive retarded superabsorbent polymer, for example into a construction material, results in a chemical reaction which leads to an enhancement of the absorption. After the reaction, the maximum absorption is attained, which is referred to hereinafter as final absorption.

After the following features which cover all variants, first the pure embodiments will be described, before mixed embodiments are finally discussed.

The inventive SAPs are notable especially in that the particular monomer units have been used in the form of free acids, in the form of salts or in a mixed form thereof.

Irrespective of the process variant used in each case to prepare the SAP, it has been found to be advantageous when the acid constituents have been neutralized after the polymerization. This is advantageously done with the aid of sodium hydroxide, potassium hydroxide, calcium hydroxide, magnesium hydroxide, sodium carbonate, potassium carbonate, calcium carbonate, magnesium carbonate, ammonia, a primary, secondary or tertiary C₁₋₂₀-alkylamine, C₁₋₂₀-alkanolamine, C₅₋₈-cycloalkylamine and/or C₆₋₁₄-arylamine, where the amines may have branched and/or unbranched alkyl groups having 1 to 8 carbon atoms. Of course, all mixtures are also suitable.

In process variants a) and/or b), the polymerization according to the present invention should have been performed especially as a free-radical bulk polymerization, solution polymerization, gel polymerization, emulsion polymerization, dispersion polymerization or suspension polymerization. Particularly suitable variants have been found to be those in which the polymerization has been performed in aqueous phase, in inverse emulsion or in inverse suspension.

It is also advisable to perform the polymerization under adiabatic conditions, in which case the reaction should preferably have been started with a redox initiator and/or a photoinitiator.

Overall, the temperature is uncritical for the preparation of the superabsorbent polymers according to the present invention. However, it has been found to be favourable not just owing to economic considerations when the polymerization has been started at temperatures between −20 and +30° C. Ranges between −10 and +20° C. and especially between 0 and 10° C. have been found to be particularly suitable as start temperatures. With regard to the process pressure too, the present invention is not subject to any restriction. This is also the reason why the polymerization can ideally be performed under atmospheric pressure and, overall, without supplying any heat at all, which is considered to be an advantage of the present invention.

The use of solvents is essentially not required either for the polymerization reaction. However, it may be found to be favourable in specific cases when the preparation of the superabsorbent polymers has been performed in the presence of at least one water-immiscible solvent and especially in the presence of an organic solvent. In the case of the organic solvents, it should preferably have been selected from the group of the linear aliphatic hydrocarbons and preferably n-pentane, n-hexane and n-heptane. However, branched aliphatic hydrocarbons (isoparaffins), cycloaliphatic hydrocarbons and preferably cyclohexane and decalin, or aromatic hydrocarbons, and here especially benzene, toluene and xylene, but also alcohols, ketones, carboxylic esters, nitro compounds, halogenated hydrocarbons, ethers, or any suitable mixtures thereof, are also useful. Organic solvents which form azeotropic mixtures with water are particularly suitable.

As already explained, the superabsorbent polymers according to the present invention are based on ethylenically unsaturated vinyl compounds. In this connection, the present invention envisages selecting these compounds from the group of the ethylenically unsaturated, water-soluble carboxylic acids and ethylenically unsaturated sulphonic acid monomers, and salts and derivatives thereof, and preferably acrylic acid, methacrylic acid, ethacrylic acid, α-chloroacrylic acid, β-cyanoacrylic acid, β-methylacrylic acid (crotonic acid), α-phenylacrylic acid, β-acryloyloxypropionic acid, sorbic acid, α-chlorosorbic acid, 2′-methylisocrotonic acid, cinnamic acid, p-chlorocinnamic acid, β-stearyl acid, itaconic acid, citraconic acid, mesaconic acid, glutaconic acid, aconitic acid, maleic acid, fumaric acid, tricarboxyethylene, maleic anhydride or any mixtures thereof.

A useful acryloyl- or methacryloylsulphonic acid is at least one representative from the group of sulphoethyl acrylate, sulphoethyl methacrylate, sulphopropyl acrylate, sulphopropyl methacrylate, 2-hydroxy-3-methacryloyloxypropylsulphonic acid and 2-acrylamido-2-methyl-propanesulphonic acid (AMPS).

Particularly suitable nonionic monomers should have been selected from the group of the water-soluble acrylamide derivatives, preferably alkyl-substituted acrylamides or aminoalkyl-substituted derivatives of acrylamide or of methacrylamide, and more preferably acrylamide, methacrylamide, N-methylacrylamide, N-methylmethacrylamide, N,N-dimethylacrylamide, N-ethylacrylamide, N,N-diethylacrylamide, N-cyclohexylacrylamide, N-benzylacrylamide, N,N-dimethylaminopropylacrylamide, N,N-dimethylaminoethylacrylamide, N-tert-butylacrylamide, N-vinylformamide, N-vinylacetamide, acrylonitrile, methacrylonitrile, or any mixtures thereof. Further suitable monomers are, in accordance with the invention, vinyllactams such as N-vinylpyrrolidone or N-vinylcaprolactam, and vinyl ethers such as methylpolyethylene glycol-(350 to 3000) monovinyl ether, or those which derive from hydroxybutyl vinyl ether, such as polyethylene glycol-(500 to 5000) vinyloxybutyl ether, polyethylene glycol-block-propylene glycol-(500 to 5000) vinyloxybutyl ether, though mixed forms are of course useful in these cases too.

The pure embodiments are described in detail hereinafter:

### Variant a): Combination of a Hydrolysis-Stable Crosslinker and of a Hydrolysis-Labile Crosslinker

In this pure embodiment a), the retardation is achieved by a specific combination of the crosslinkers. The combination of two or more crosslinkers in a superabsorbent polymer is nothing new per se. It is discussed in detail, for example, in U.S. Pat. No. 5,837,789. In the past, the combination of crosslinkers has been used, however, in order to improve the antagonistic properties of absorption capacity and extractable polymer content, and of absorption capacity and permeability. Specifically, a high absorption is promoted by small amounts of crosslinker; however, this leads to increased extractable polymer content and vice versa. The combination of different crosslinkers forms, overall, better products over the three properties of absorption capacity, soluble fraction and permeability. The retardation of the swelling by several minutes by virtue of a crosslinker combination and more particularly to >10 minutes has to date been unknown. When, for example, in the area of superabsorbent polymers for nappies, a time delay is established in order that the liquid is first distributed within the nappy and then absorbed, it is typically in the region of a few seconds.

Preferably, the inventive superabsorbents of this embodiment a) are present either in the form of anionic or cationic polyelectrolytes, but essentially not as polyampholytes. Polyampholytes are understood to mean polyelectrolytes which bear both cationic and anionic charges on the polymer chain. Preference is thus given in this case to copolymers of purely anionic or purely cationic nature and not polyampholytes. However, up to 10 mol %, preferably less than 5 mol %, of the total charge of a polyelectrolyte may be replaced by components of opposite charge. This applies both in the case of predominantly anionic copolymers with a relatively small cationic component and also conversely to predominantly cationic copolymers with a relatively small anionic component.

Suitable monomers for anionic superabsorbent polymers are, for example, ethylenically unsaturated, water-soluble carboxylic acids and carboxylic acid derivatives or ethylenically unsaturated sulphonic acid monomers.

Preferred ethylenically unsaturated carboxylic acid or carboxylic anhydride monomers are acrylic acid, methacrylic acid, ethacrylic acid, α-chloroacrylic acid, α-cyanoacrylic acid, β-methylacrylic acid (crotonic acid), α-phenylacrylic acid, β-acryloyloxypropionic acid, sorbic acid, α-chlorosorbic acid, 2′-methylisocrotonic acid, cinnamic acid, p-chlorocinnamic acid, β-stearyl acid, itaconic acid, citraconic acid, mesaconic acid, glutaconic acid, aconitic acid, maleic acid, fumaric acid, tricarboxyethylene and maleic anhydride, particular preference being given to acrylic acid and methacrylic acid. Ethylenically unsaturated sulphonic acid monomers are preferably aliphatic or aromatic vinylsulphonic acids or acrylic or methacrylic sulphonic acids. Preferred aliphatic or aromatic vinylsulphonic acids are vinylsulphonic acid, allylsulphonic acid, vinyltoluenesulphonic acid and styrenesulphonic acid.

Preferred acryloyl- and methacryloylsulphonic acids are sulphoethyl acrylate, sulphoethyl methacrylate, sulphopropyl acrylate, sulphopropyl methacrylate, 2-hydroxy-3-methacryloyloxypropylsulphonic acid and 2-acrylamido-2-methylpropanesulphonic acid, particular preference being given to 2-acrylamido-2-methylpropanesulphonic acid.

All acids listed may have been polymerized as free acids or as salts. Of course, partial neutralization is also possible. In addition, some or all of the neutralization may also be effected only after the polymerization. The monomers can be neutralized with alkali metal hydroxides, alkaline earth metal hydroxides or ammonia. In addition, any further organic or inorganic base which forms a water-soluble salt with the acid is conceivable. Mixed neutralization with different bases is also conceivable. A preferred feature of the invention is neutralization with ammonia and alkali metal hydroxides, and more preferably with sodium hydroxide.

In addition, further nonionic monomers with which the number of anionic charges in the polymer chain can be adjusted may also have been used. Possible water-soluble acrylamide derivatives are alkyl-substituted acrylamides or aminoalkyl-substituted derivatives of acrylamide or of methacrylamide, for example acrylamide, methacrylamide, N-methyl-acrylamide, N-methylmethacrylamide, N,N-dimethylacrylamide, N-ethylacrylamide, N,N-diethylacrylamide, N-cyclohexylacrylamide, N-benzylacrylamide, N,N-dimethyl-aminopropylacrylamide, N,N-dimethylaminoethylacrylamide and/or N-tert-butylacrylamide. Further suitable nonionic monomers are N-vinylformamide, N-vinylacetamide, acrylonitrile and methacrylonitrile, but also vinyllactams such as N-vinylpyrrolidone or N-vinylcaprolactam, and vinyl ethers such as methylpolyethylene glycol-(350 to 3000) monovinyl ether, or those which derive from hydroxybutyl vinyl ether, such as polyethylene glycol-(500 to 5000) vinyloxybutyl ether, polyethylene glycol-block-propylene glycol-(500 to 5000) vinyloxybutyl ether, and suitable mixtures thereof.

In addition, the inventive superabsorbent polymers comprise at least two crosslinkers: in general, a crosslinker forms a bond between two polymer chains, which leads to the superabsorbent polymers forming water-swellable but water-insoluble networks. One class of crosslinkers is that of monomers with at least two independently incorporable double bonds which lead to the formation of a network. In the context of the present invention, at least one crosslinker from the group of the hydrolysis-stable crosslinkers and at least one crosslinker from the group of the hydrolysis-labile crosslinkers was selected. According to the invention, a hydrolysis-stable crosslinker shall be understood to mean a crosslinker which, incorporated in the network, maintains its crosslinking action at all pH values. The linkage points of the network thus cannot be broken up by a change in the swelling medium. This contrasts with the hydrolysis-labile crosslinker which, incorporated in the network, can lose its crosslinking action through a change in the pH. One example of this is a diacrylate crosslinker which loses its crosslinking action through alkaline ester hydrolysis at a high pH.

Possible hydrolysis-stable crosslinkers are N,N′-methylenebisacrylamide, N,N′-methylenebis-methacrylamide and monomers having more than one maleimide group, such as hexamethylenebismaleimide; monomers having more than one vinyl ether group, such as ethylene glycol divinyl ether, triethylene glycol divinyl ether and/or cyclohexanediol divinyl ether. It is also possible to use allylamino or allylammonium compounds having more than one allyl group, such as triallylamine and/or tetraallylammonium salts. The hydrolysis-stable crosslinkers also include the allyl ethers, such as tetraallyloxyethane and pentaerythritol triallyl ether.

The group of the monomers having more than one vinylaromatic group includes divinylbenzene and triallyl isocyanurate.

A preferred feature of the present invention is that, in process variant a), the hydrolysis-stable crosslinker used was at least one representative from the group of N,N′-methylenebisacrylamide, N,N′-methylenebismethacrylamide or monomers having at least one maleimide group, preferably hexamethylenebismaleimide, monomers having more than one vinyl ether group, preferably ethylene glycol divinyl ether, triethylene glycol divinyl ether, cyclohexanediol divinyl ether, allylamino or allylammonium compounds having more than one allyl group, preferably triallylamine or a tetraallylammonium salt such as tetraallylammonium chloride, or allyl ethers having more than one allyl group, such as tetraallyloxyethane and pentaerythritol triallyl ether, or monomers having vinylaromatic groups, preferably divinylbenzene and triallyl isocyanurate, or diamines, triamines, tetramines or higher-functionality amines, preferably ethylenediamine and diethylenetriamine.

Hydrolysis-labile crosslinkers may be: poly-(meth)acryloyl-functional monomers, such as 1,4-butanediol diacrylate, 1,4-butanediol dimethacrylate, 1,3-butylene glycol diacrylate, 1,3-butylene glycol dimethacrylate, diethylene glycol diacrylate, diethylene glycol dimethacrylate, ethylene glycol diacrylate, ethylene glycol dimethacrylate, ethoxylated bisphenol A diacrylate, ethoxylated bisphenol A dimethacrylate, 1,6-hexanediol diacrylate, 1,6-hexanediol dimethacrylate, neopentyl glycol dimethacrylate, polyethylene glycol diacrylate, polyethylene glycol dimethacrylate, triethylene glycol diacrylate, triethylene glycol dimethacrylate, tripropylene glycol diacrylate, tetraethylene glycol diacrylate, tetraethylene glycol dimethacrylate, dipentaerythritol pentaacrylate, pentaerythritol tetraacrylate, pentaerythritol triacrylate, trimethylolpropane triacrylate, trimethylolpropane trimethacrylate, cyclopentadiene diacrylate, tris(2-hydroxyethyl) isocyanurate triacrylate and/or tris(2-hydroxyethyl) isocyanurate trimethacrylate; monomers having more than one vinyl ester or allyl ester group with corresponding carboxylic acids, such as divinyl esters of polycarboxylic acids, diallyl esters of polycarboxylic acids, triallyl terephthalate, diallyl maleate, diallyl fumarate, trivinyl trimellitate, divinyl adipate and/or diallyl succinate.

The preferred representatives of the hydrolysis-labile crosslinkers used in preparation variant a) were compounds which were selected from the group of the di-, tri- or tetra(meth)acrylates, such as 1,4-butanediol diacrylate, 1,4-butanediol dimethacrylate, 1,3-butylene glycol diacrylate, 1,3-butylene glycol dimethacrylate, diethylene glycol diacrylate, diethylene glycol dimethacrylate, ethylene glycol diacrylate, ethylene glycol dimethacrylate, ethoxylated bisphenol A diacrylate, ethoxylated bisphenol A dimethacrylate, 1,6-hexanediol diacrylate, 1,6-hexanediol dimethacrylate, neopentyl glycol dimethacrylate, polyethylene glycol diacrylate, polyethylene glycol dimethacrylate, triethylene glycol diacrylate, triethylene glycol dimethacrylate, tripropylene glycol diacrylate, tetraethylene glycol diacrylate, tetraethylene glycol dimethacrylate, dipentaerythritol pentaacrylate, pentaerythritol tetraacrylate, pentaerythritol triacrylate, trimethylolpropane triacrylate, trimethylolpropane trimethacrylate, cyclopentadiene diacrylate, tris(2-hydroxyethyl) isocyanurate triacrylate and/or tris(2-hydroxyethyl) isocyanurate trimethacrylate, the monomers having more than one vinyl ester or allyl ester group with corresponding carboxylic acids, such as divinyl esters of polycarboxylic acids, diallyl esters of polycarboxylic acids, triallyl terephthalate, diallyl maleate, diallyl fumarate, trivinyl trimellitate, divinyl adipate and/or diallyl succinate, or at least one representative of the compounds having at least one vinylic or allylic double bond and at least one epoxy group, such as glycidyl acrylate, ally(glycidyl ether, or the compounds having more than one epoxy group, such as ethylene glycol diglycidyl ether, diethylene glycol diglycidyl ether, polyethylene glycol diglycidyl ether, polypropylene glycol diglycidyl ether, or the compounds having at least one vinylic or allylic double bond and at least one (meth)acrylate group, such as polyethylene glycol monoallyl ether acrylate or polyethylene glycol monoallyl ether methacrylate.

Further crosslinkers which contain functional groups both from the class of the hydrolysis-labile crosslinkers and of the hydrolysis-stable crosslinkers should be included among the hydrolysis-labile crosslinkers when they form not more than one hydrolysis-stable crosslinking point. Typical examples of such crosslinkers are polyethylene glycol monoallyl ether acrylate and polyethylene glycol monoallyl ether methacrylate.

In addition to the crosslinkers having two or more double bonds, there are also those which have only one or no double bond, but do have other functional groups which can react with the monomers and which lead to crosslinking points during the preparation process. Two frequently used functional groups are in particular epoxy groups and amino groups. Examples of such crosslinkers with a double bond are glycidyl acrylate, allyl glycidyl ether. Examples of crosslinkers without a double bond are diamines, triamines or compounds having four or more amino groups, such as ethylenediamine, diethylenetriamine, or diepoxides such as ethylene glycol diglycidyl ether, diethylene glycol diglycidyl ether, polyethylene glycol diglycidyl ether, polypropylene glycol diglycidyl ether.

In the preparation of the inventive SAPs, sufficiently high total amounts of crosslinker as to give rise to a very close-mesh network are typically used. The polymeric product thus has only a low absorption capacity after short times (>5 min; <10 min).

The amounts of the hydrolysis-stable crosslinkers used in process variant a) were between 0.01 and 1.0 mol %, preferably between 0.03 and 0.7 mol % and more preferably 0.05 to 0.5 mol %. Significantly higher amounts of the hydrolysis-labile crosslinkers are required: according to the invention, 0.1 to 10.0 mol %, preferably 0.3 to 7 mol % and more preferably 0.5 to 5.0 mol % were used.

Under the use conditions preferred in accordance with the invention, the hydrolysis-labile network links formed in the course of polymerization are broken again. The absorption capacity of the inventive superabsorbent polymer is increased significantly as a result. The required amounts of the crosslinkers should, though, be adjusted to the particular application and should be determined in performance tests (for construction materials particularly in the time-dependent slump).

Cationic superabsorbent polymers contain exclusively cationic monomers. For cationic superabsorbent polymers of embodiment a), it is possible to use all monomers with a permanent cationic charge. “Permanent” means in turn that the cationic charge remains predominantly stable in an alkaline medium; an ester quat is, for example, unsuitable. The nonionic comonomers and crosslinkers used may be all monomers listed among the anionic superabsorbent polymers, employing the abovementioned molar ratios. Possible cationic monomers are: [3-(acryloylamino)propyl]trimethylammonium salts and/or [3-(methacryloylamino)propyl]trimethylammonium salts. The salts mentioned are preferably present in the form of halides, sulphates or methosulphates. In addition, it is possible to use diallyldimethylammonium chloride.

The inventive anionic or cationic superabsorbent copolymers can be prepared in a manner known per se by joining the monomers which form the particular structural units by free-radical polymerization. All monomers present in acid form can be polymerized as free acids or in the salt form thereof. In addition, the acids can be neutralized by adding appropriate bases even after the copolymerization; partial neutralization before or after the polymerization is likewise possible. The monomers or the copolymers can be neutralized, for example, with the bases sodium hydroxide, potassium hydroxide, calcium hydroxide, magnesium hydroxide and/or ammonia. Likewise suitable as bases are C₁- to C₂₀-alkylamines, C₁- to C₂₀-alkanolamines, C₅- to C₈-cycloalkylamines and/or C₆- to C₁₄-arylamines, each of which has primary, secondary or tertiary and in each case branched or unbranched alkyl groups. It is possible to use one base or a plurality. Preference is given to neutralization with alkali metal hydroxides and/or ammonia; sodium hydroxide is particularly suitable. The inorganic or organic bases should be selected such that they form readily water-soluble salts with the particular acid.

For all aminic bases and ammonia, it should be checked in the application whether the alkaline medium which is formed by the pore water forms a fishy and/or ammoniacal odour, since this may possibly be a criterion for exclusion.

As likewise already mentioned in general terms, the monomers should preferably be copolymerized by free-radical bulk polymerization, solution polymerization, gel polymerization, emulsion polymerization, dispersion polymerization or suspension polymerization. Since the inventive products are hydrophilic and water-swellable copolymers, polymerization in aqueous phase, polymerization in inverse emulsion (water-in-oil) and polymerization in inverse suspension (water-in-oil) are preferred variants. In particularly preferred embodiments, the reaction is effected as a gel polymerization or else as an inverse suspension polymerization in organic solvents.

Process variant a) may also have been performed as an adiabatic polymerization, and may have been started either with a redox initiator system or with a photoinitator. However, a combination of both variants of the initiation is also possible. The redox initiator system consists of at least two components, an organic or inorganic oxidizing agent and an organic or inorganic reducing agent. Frequently, compounds with peroxide units are used, for example inorganic peroxides such as alkali metal persulphate and ammonium persulphate, alkali metal perphosphates and ammonium perphosphates, hydrogen peroxide and salts thereof (sodium peroxide, barium peroxide), or organic peroxides such as benzoyl peroxide, butyl hydroperoxide, or peracids such as peracetic acid. In addition, it is also possible to use other oxidizing agents, for example potassium permanganate, sodium chlorate and potassium chlorate, potassium dichromate, etc. The reducing agents used may be sulphur compounds such as sulphites, thiosulphates, sulphinic acid, organic thiols (for example ethyl mercaptan, 2-hydroxyethanethiol, 2-mercaptoethylammonium chloride, thioglycolic acid) and others. In addition, ascorbic acid and low-valency metal salts [copper(I); manganese(II); iron(II)] are suitable. Phosphorus compounds, for example sodium hypophosphite, can also be used. As their name suggests, photopolymerizations are started with UV light, which results in the decomposition of a photoinitiator. The photoinitiators used may, for example, be benzoin and benzoin derivatives, such as benzoin ethers, benzil and derivatives thereof, such as benzil ketals, aryldiazonium salts, azo initiators, for example 2, 2′-azobis(isobutyronitrile), 2,2′-azobis(2-amidinopropane) hydrochloride and/or acetophenone derivatives. The proportion by weight of the oxidizing component and of the reducing component in the case of the redox initiator systems is preferably in each case in the range between 0.00005 and 0.5% by weight, more preferably in each case between 0.001 and 0.1% by weight. For photoinitiators, this range is preferably between 0.001 and 0.1% by weight and more preferably between 0.002 and 0.05% by weight. The percentages by weight stated for the oxidizing and reducing components and the photoinitiators are based in each case on the mass of the monomers used for the copolymerization. The polymerization conditions, especially the amounts of initiator, are always selected with the aim of obtaining very long-chain polymers. Owing to the insolubility of the crosslinked copolymers, the determination of the molecular weights is, however, possible only with great difficulty.

The copolymerization is preferably performed in aqueous solution, especially in concentrated aqueous solution, batchwise in a polymerization vessel (batchwise process) or continuously by the “endless belt” method described, for example, in U.S. Pat. No. 4,857,610. A further possibility is polymerization in a continuous or batchwise kneading reactor. The process is started typically at a temperature between −20 and 20° C., preferably between −10 and 10° C., and performed at atmospheric pressure and without external heat supply, the heat of polymerization resulting in a maximum end temperature, depending on the monomer content, of 50 to 150° C. The end of the copolymerization is generally followed by crushing of the polymer present in gel form. In the case of performance on the laboratory scale, the crushed gel is dried in a forced air drying cabinet at 70 to 180° C., preferably at 80 to 150° C. On the industrial scale, the drying can also be effected in a continuous manner within the same temperature ranges, for example on a belt dryer or in a fluidized bed dryer. In a further preferred embodiment, the copolymerization is effected as an inverse suspension polymerization of the aqueous monomer phase in an organic solvent. The procedure here is preferably to polymerize the monomer mixture which has been dissolved in water and optionally neutralized in the presence of an organic solvent in which the aqueous monomer phase is soluble sparingly, if at all. Preference is given to working in the presence of “water-in-oil” emulsifiers (W/O emulsifiers) and/or protective colloids based on low or high molecular weight compounds which are used in proportions of 0.05 to 5% by weight, preferably 0.1 to 3% by weight (based in each case on the monomers). The W/O emulsifiers and protective colloids are also referred to as stabilizers. It is possible to use customary compounds known as stabilizers in inverse suspension polymerization technology, such as hydroxypropylcellulose, ethylcellulose, methylcellulose, cellulose acetate butyrate mixed ethers, copolymers of ethylene and vinyl acetate, of styrene and butyl acrylate, polyoxyethylene sorbitan monooleate, monolaurate or monostearate, and block copolymers of propylene oxide and/or ethylene oxide. Suitable organic solvents are, for example, linear aliphatic hydrocarbons such as n-pentane, n-hexane, n-heptane, branched aliphatic hydrocarbons (isoparaffins), cycloaliphatic hydrocarbons such as cyclohexane and decalin, and aromatic hydrocarbons such as benzene, toluene and xylene. Further suitable solvents are alcohols, ketones, carboxylic esters, nitro compounds, halogenated hydrocarbons, ethers and many other organic solvents. Preference is given to organic solvents which form azeotropic mixtures with water, particular preference to those which have a very high water content in the azeotrope.

The water-swellable copolymers (SAP precursor) are initially obtained in swollen form as finely distributed aqueous droplets in the organic suspension medium, and are preferably isolated as solid spherical particles in the organic suspension medium by removing the water by azeotropic distillation. Removal of the suspension medium and drying leaves a pulverulent solid. Inverse suspension polymerization is known to have the advantage that variation of the polymerization conditions allows the particle size distribution of the powders to be controlled. An additional process step (grinding operation) to adjust the particle size distribution can usually be avoided as a result.

The monomers and crosslinkers should be selected taking account of the particular requirements, some of them specific, of the application. For instance, in the case of high salinity in the construction material, salt-stable monomer compositions should be employed, which may be based, for example, on sulphonic acid-based monomers. In this case, the final absorption is established via the monomer composition and the hydrolysis-stable crosslinkers, while the hydrolysis-labile crosslinker influences the kinetics of the swelling. However, it should be taken into account that the monomer composition and the crosslinker can also have a certain influence on the kinetics, which is different from case to case and, in particular, is less marked with respect to the influence of the hydrolysis-labile crosslinker. Both the hydrolysis-stable crosslinker and the hydrolysis-labile crosslinker should, according to the invention, be incorporated homogeneously. Otherwise, for example, regions depleted of hydrolysis-labile crosslinker would form and would therefore begin to swell rapidly, without exhibiting the desired time delay. Too high a reactivity of the crosslinker can lead to it already being consumed before the end of the polymerization, and so no further crosslinker is available at the end of the polymerization. Too low a reactivity has the effect that, at the start of the polymerization, regions low in crosslinker are formed. In addition, there is always the risk that the second double bond is not incorporated fully—the crosslinking function would thus be absent. The length of the bridge between the crosslinking points may likewise have an influence on the hydrolysis kinetics. Steric hindrance can slow the hydrolysis. Overall, the selection of the composition of the superabsorbent polymer is influenced by the application (construction material system and time window for the hydrolysis). However, the present invention provides sufficient possible variations and selections, and so it is possible without any problems to select suitable hydrolysis-stable or hydrolysis-labile crosslinkers, for example in order to ensure a homogeneous network.

Variant b): Combination of a Permanently Anionic Monomer with a Hydrolysable Cationic Monomer

In this second embodiment, the time delay of the swelling action of the SAP is achieved through a specific combination of the monomers.

The superabsorbents of this embodiment b) of the invention are present in the form of polyampholytes. Polyampholytes are understood to mean polyelectrolytes which bear both cationic and anionic charges on the polymer chain. Combination of cationic and anionic charge within the polymer chain results in the formation of strong intramolecular attraction forces which lead to the absorption capacity being reduced significantly, or even approaching zero.

In embodiment b), the cationic monomers were selected such that they lose their cationic charge with time and become uncharged or even anionic. The two following reaction schemes are intended to illustrate this in detail:

In the first case, a cationic ester quat, as a polymerized constituent of the SAP, is converted in the course of application by an alkaline hydrolysis to a carboxylate,
In the second case, a cationic acrylamide derivative becomes nonionic as a result of a neutralization.

Useful anionic monomers in this process variant b) are all anionic monomers already mentioned for process variant a). Preferred representatives in accordance with the invention are considered to be those from the group of the ethylenically unsaturated water-soluble carboxylic acids and ethylenically unsaturated sulphonic acid monomers, and salts and derivatives thereof, especially acrylic acid, methacrylic acid, ethacrylic acid, α-chloroacrylic acid, α-cyanoacrylic acid, β-methylacrylic acid (crotonic acid), α-phenylacrylic acid, β-acryloyloxypropionic acid, sorbic acid, α-chlorosorbic acid, 2′-methylisocrotonic acid, cinnamic acid, p-chlorocinnamic acid, β-stearyl acid, itaconic acid, citraconic acid, mesaconic acid, glutaconic acid, aconitic acid, maleic acid, fumaric acid, tricarboxyethylene and maleic anhydride, more preferably acrylic acid, methacrylic acid, aliphatic or aromatic vinylsulphonic acids, and especially preferably vinylsulphonic acid, allylsulphonic acid, vinyltoluenesulphonic acid, styrenesulphonic acid, acryloyl- and methacryloylsulphonic acids, and even more preferably sulphoethyl acrylate, sulphoethyl methacrylate, sulphopropyl acrylate, sulphopropyl methacrylate, 2-hydroxy-3-methacryloyloxypropylsulphonic acid and 2-acrylamido-2-methylpropanesulphonic acid (AMPS), or mixtures thereof.

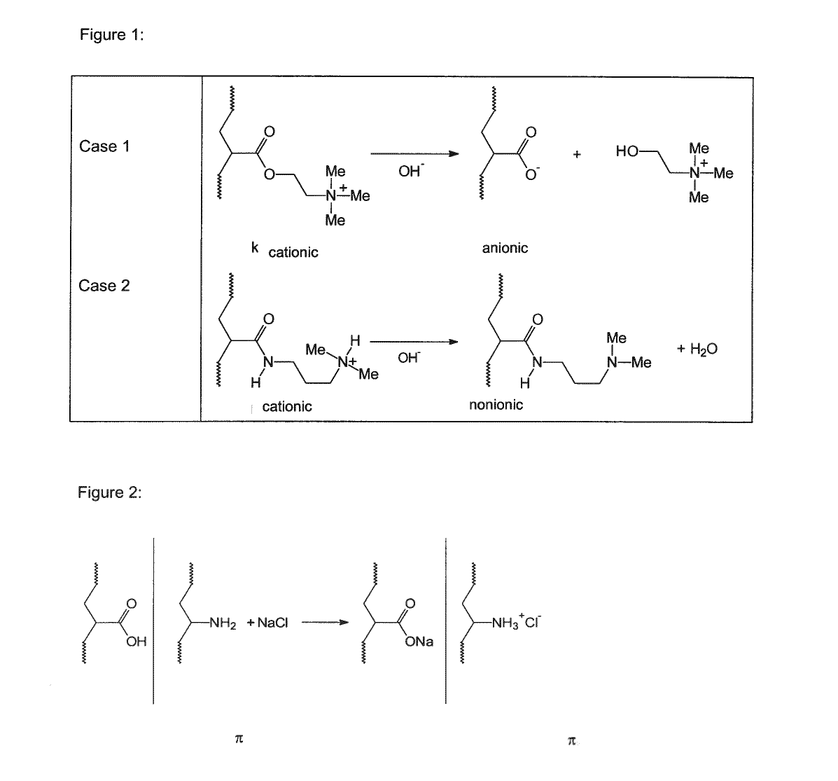

Cationic monomers for Case 1 in FIG. 1 may, for example, be: [2-(acryloyloxy)ethyl]tri-methylammonium salts and [2-(methacryloyloxy)ethyl]trimethylammonium salts. In principle, all polymerizable cationic esters of vinyl compounds whose cationic charge can be eliminated by hydrolysis are conceivable.

Cationic monomers for Case 2 in FIG. 1 may, for example, be: salts of 3-dimethylaminopropylacrylamide or 3-dimethylaminopropylmethacrylamide, preference being given to the hydrochloride and hydrosulphate. In principle, all monomers which are vinylically polymerizable and bear an amino function which can be protonated can be used. Preferred representatives of the cationic monomers are, according to the present invention, polymerizable cationic esters of vinyl compounds whose cationic charge can be eliminated by hydrolysis, preferably [2-(acryloyloxy)ethyl]trimethylammonium salts and [2-(methacryloyloxy)ethyl]trimethylammonium salts, or monomers which are vinylically polymerizable and bear an amino function which can be protonated, preferably salts of 3-dimethylaminopropylacrylamide or 3-dimethylaminopropylmethacrylamide, and more preferably the hydrochloride and hydrosulphate thereof, or mixtures thereof.

Since the inventive SAPs prepared by process variant b) are suitable in particular for applications having a high pH, which is the case especially in cementitious systems, at least one crosslinker should be selected from the above-described group of the hydrolysis-stable crosslinkers.

The present invention also envisages that the SAPs can be prepared by all variants as have already been described under embodiment a).

To control the retardation, it is possible in principle to incorporate additional monomers from the group of the above-described nonionic monomers into the inventive superabsorbent polymer. The use of nonionic monomers brings about an acceleration of the increase in the absorption capacity.

For the second process variant b) of the invention too, it is important first to achieve an absorption of close to zero in demineralized water. This is achieved through the selection of the correct amounts of cationic and anionic monomers, Ideally, the minimum absorption is achieved at a molar ratio of the cationic to anionic monomers of 1:1. In the case of weak acids or bases, it may be necessary to establish a molar ratio which deviates from 1:1 (for example 1.1 to 2.0:2.0 to 1.1).

If relatively fast retarded swelling is required, a low absorption can also be established. This too is achieved by a monomer composition deviating from the ratio of 1:1 (for example 1.1 to 2.0:2,0 to 1.1). As a result of the low residual absorption, the retarded superabsorbent polymer absorbs a little water or aqueous solution in the application, and the neutralization/hydrolysis takes place more rapidly. In all cases of process variant b), the molar ratio of anionic to cationic monomer is 0.3 to 2.0:1.0, preferably from 0.5 to 1.5:1.0 and more preferably 0.7 to 1.3:1.0.

A further means in principle of controlling the kinetics is the addition of salt. Polyampholytes often have an inverse electrolyte effect, i.e. the addition of salts increases the solubility in water. This salt is added to the monomer solution. In the case of gel polymerization, it may, though, also be added to the gel as an aqueous solution.

The selection of the crosslinkers likewise allows the kinetics of the swelling to be influenced. The type and the amount of crosslinker are additionally crucial for the absorption behaviour of the retarded superabsorbent polymer after the complete hydrolysis/neutralization of the cationic monomers. Again, the swelling kinetics and the final absorption should be and can be adjusted to the particular application. In this case, both the application and the raw materials of the formulation again play a major role.

A further possible variant of this embodiment is that of the so-called interpenetrating network: in this case, two networks are formed within one another. One network is formed from a polymer of cationic monomers, the second from anionic monomers. The charges should balance overall. It may be found to be favourable to additionally incorporate nonionic monomers into the network. Interpenetrating networks are prepared by initially charging a cationic (or anionic) polymer in an anionic (or cationic) monomer solution and then polymerizing. The crosslinking should be selected such that the two polymers form a network: the initially charged polymer and the newly formed polymer.

Variant c: Coating with an Oppositely Charged Solution Polymer

In this third process variant c), the retardation is achieved through a specific surface treatment of the superabsorbent polymer. In this case, the charged superabsorbent polymer is coated with an oppositely charged polymer. The balancing of the charges on the polymer surface, as preferably provided by the present invention, forms a water-impermeable simplex layer which prevents swelling of the superabsorbent polymer within the first few minutes.

This surface treatment should become detached from the SAP with time (at least 10 to 15 minutes!), which significantly increases the absorption capacity of the superabsorbent polymer.

The surface treatment of anionic superabsorbent polymers, preferably crosslinked, partly neutralized polyacrylic acids, with cationic polymers has already been described in a series of patents:

The already cited publications WO 2006/082188 and WO 2006/082189 describe surface treatment with one to two percent of polyamine; in DE 10 2005 018922, polyDADMAC (polydiallyldimethylammonium chloride) is applied to superabsorbent polymers. In the course of polyamine coating, crosslinking components are present. This involves spraying cationic polymers as aqueous solutions onto the granular superabsorbent polymer. The superabsorbent polymers thus obtained have a higher permeability and a lower tendency to form lumps in the course of storage, i.e. remain free-flowing for longer. Since these SAPs have been developed exclusively for use in nappies, they of course must not have a time delay in the range of minutes. EP 1 393 757 A1 describes surface coating with partly hydrolysed polyvinylformamide. This leads to improved performance in the nappy.

WO 2003/43670 likewise describes the crosslinking of polymers which have been applied to the surface.

Generally, in accordance with the invention, cationic polymers with a molecular weight of 5 million g/mol or less are used, which, as a 10 to 20% aqueous solution, give rise to a sprayable solution (viscosity). They are polymerized as an aqueous solution and used for surface treatment. In the standard processes, the superabsorbent polymer is initially charged, for example in a fluidized bed, and sprayed with a polymer solution. Generally, “highly cationic” polymers are used, i.e. those whose cationic monomers make up at least 75 mol % of the composition.

The present invention prefers the use of shell polymers with a molecular weight of ≦3 million g/mol, preferably ≦2 million g/mol and more preferably <1.5 million g/mol, and the selected shell polymers should have either anionic or cationic properties. Ampholytes are not used.

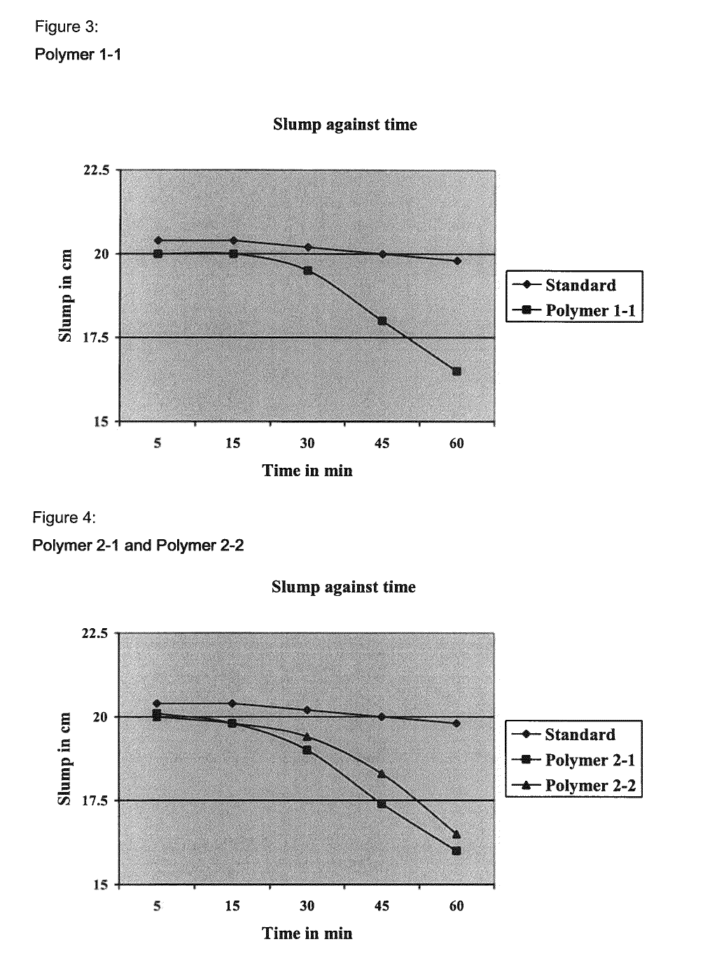

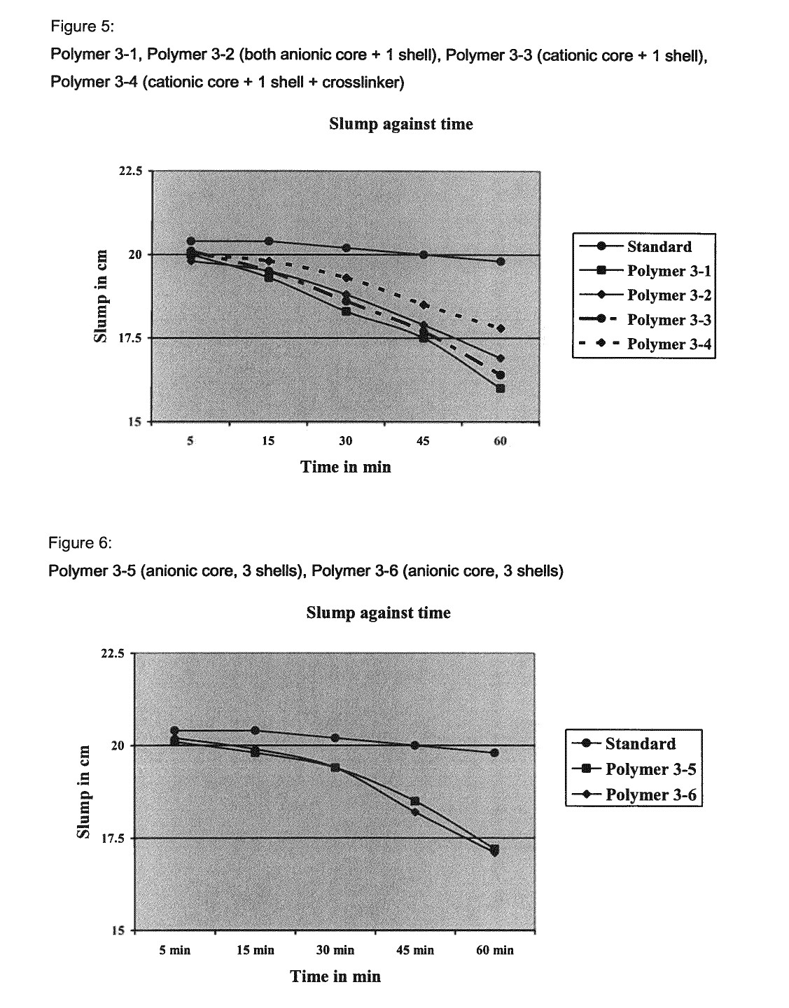

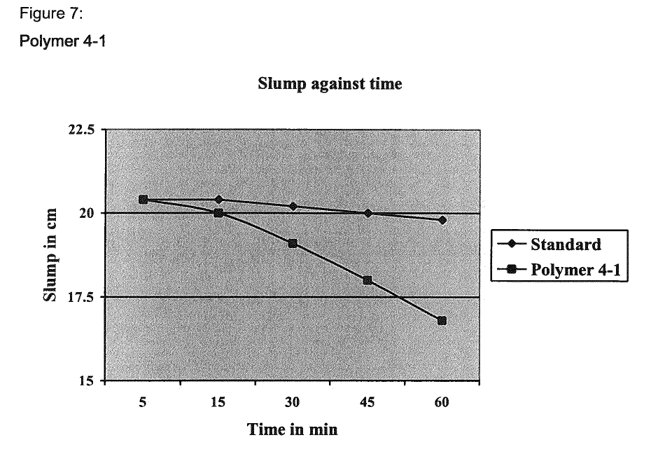

A further combination of cationic and anionic polyelectrolytes is that of MBIE-superabsorbent polymers, where MBIE stands for “mixed bed ion exchange”. Such products are described, inter alia, in U.S. Pat. No. 6,603,056 and the patents cited there: a potentially anionic superabsorbent polymer is mixed with a superabsorbent cationic polymer. “Potentially anionic” means that, in the embodiments of the invention, the anionic superabsorbent polymer is used in acidic form. While the purely anionic superabsorbent polymers are usually polyacrylic acids neutralized to an extent of approx. 70%, crosslinked polyacrylic acids which are neutralized only to a low degree, if at all, are used here. The combination with a cationic polymer leads to a more salt-stable product; the salts are effectively neutralized by ion exchange, as shown in FIG. 2 below. The neutralized acid then possesses the appropriate osmotic pressure (π) for significant swelling.

This concept for superabsorbent polymers was also developed exclusively for use in hygiene articles, specifically in nappies, and is thus again aimed at fast superabsorbent polymers. The combination of anionic and cationic superabsorbent polymer to provide a superabsorbent polymer retarded in the range of minutes has not been described to date.

The starting material used for the surface treatment in the present invention may be any superabsorbent polymer which has sufficient absorption capacity in cementitious systems in particular. It may be either anionic or cationic. The starting material shall be referred to hereinafter as “core polymer”. The polymer which is applied to the surface shall be referred to hereinafter as “shell polymer”. The core polymers are anionic or cationic superabsorbent polymers, preferably in the sense of process variant a), which have especially ≦10% by weight of comonomers with opposite charge. In contrast to variant a), the core polymers used in pure embodiment c) are, however, only superabsorbent polymers which are formed exclusively from hydrolysis-stable crosslinkers. This variant is considered to be preferred. Apart from the restriction for the crosslinkers, the synthesis of the anionic core polymers corresponds to that described in process variant a). For the present case too, it is also possible to use all monomers already described there.

For cationic core polymers, it is possible to use all monomers with a permanent cationic charge. “Permanent” in turn means that the cationic charge is maintained in alkaline medium; an ester quat is thus unsuitable. Preference is given to: [3-(acryloylamino)propyl]trimethyl-ammonium salts and [3-(methacryloylamino)propyl]trimethylammonium salts. The salts mentioned are preferably present as halides, methosulphates or sulphates. In addition, it is possible to use diallyldimethylammonium chloride.

For the treatment of the surface, two preferred processes are possible, both of which are also described in U.S. Pat. No. 6,603,056:

One process is basically a conventional powder coating. The core polymer is initially charged and set in motion, for example in a fluidized bed. Subsequently, the oppositely charged shell polymer is applied. Finally, the product is dried. This process is suitable in particular when relatively small amounts of shell polymer based on the core polymer are to be applied. In the case of larger amounts in this process, agglomeration of the particles occurs and the product cakes together. This leads to the surfaces no longer being coated homogeneously. In order to apply large amounts of shell polymer, this process step has to be carried out repeatedly.

For larger amounts of shell polymer, a second process is suitable: in this process, the core polymer is suspended in an organic solvent. The shell polymer solution is added to the suspension, and then, for electrostatic reasons, the core polymer is coated with an oppositely charged shell. For very small particles too, this process is advantageous since they are difficult to handle in a fluidized bed.

After the addition of the shell polymer solution, the amount of water added through the solution can optionally be distilled off azeotropically. Therefore, preferred organic solvents are considered to be those which form an azeotrope with a maximum water content, in which the superabsorbent polymer and the shell polymer are insoluble. For this process, it is possible to use the same solvents which are also specified in process variant a) among the solvents for the suspension polymerization. It has also been found to be advantageous to add a protective colloid, as is also done in the suspension polymerization. Again, it is possible to select from the protective colloids described there.

For the surface coating, as described, a shell polymer is applied to the core polymer. The shell polymer is preferably applied as an aqueous solution and is especially used as a sprayable solution, particularly suitable solutions being those having a viscosity of from 200 to 7500 mPas. Working with organic solvents is very complicated in this process, particularly on the industrial scale. For both processes just described, it is favourable to work with low-viscosity solutions since they can be sprayed better and also become attached more readily to the surface of the suspended core polymer.

Since the molecular weight of the shell polymer has a significant influence on the viscosity, shell polymers with a molecular weight of less than 5 million g/mol are preferred. Moreover, it is envisaged in accordance with the invention that the further polyelectrolyte, i.e. the shell polymer, has a proportion of cationic monomer of ≧75 mol %, preferably ≧80 mol % and more preferably between 80 and 100 mol %.

In principle, it is possible to prepare such cationic or anionic shell polymers either by the process of gel polymerization or by that of suspension polymerization, and then to redissolve the resulting polymers and to apply them as an aqueous shell polymerization solution. However, it is more advantageous to perform the polymerization as a solution polymerization, such that the product of the polymerization can be used directly and no more than a dilution is still necessary, The molecular weight of the shell polymers can be reduced by the addition of chain regulators, which allows the desired chain length and hence also the desired viscosity to be obtained. The procedure is preferably as follows:

The monomers are dissolved in water or their commercially obtainable aqueous solutions are diluted. Then the chain regulator(s) is/are added and the pH is adjusted. Subsequently, the aqueous monomer solution is inertized with nitrogen and heated to the start temperature. With the addition of the initiators, the polymerization is started and proceeds generally within a few minutes. The concentration of the shell polymer is selected at a maximum level in order that the amount of water to be removed is at a minimum, but the viscosity can still be handled readily in the processes according to the invention, such as spraying, coating in suspension. It may be advantageous to heat the shell polymer solution since the viscosity at the same concentration falls at higher temperatures. Suitable chain regulators are formic acid or salts thereof, for example sodium formate, hydrogen peroxide, compounds which comprise a mercapto group (R-SH) or a mercaptate group (R-S-M+), where the R radical here may in each case be an organic aliphatic or aromatic radical having 1 to 16 carbon atoms (for example mercaptoethanol, 2-mercaptoethylamine, 2-mercaptoethylammonium chloride, thioglycolic acid, mercaptoethanesulphonate (sodium salt), cysteine, trismercaptotriazole (TMT) as the sodium salt, 3-mercaptotriazole, 2-mercapto-1-methylimidazole), compounds which comprise an R-S-S-R′ group (disulphite group), where the R and R′ radicals here may each independently be an organic aliphatic or aromatic radical having 1 to 16 carbon atoms (for example cystaminium dichloride, cysteine), phosphorus compounds, such as hypophosphorous acid and salts thereof (e.g. sodium hypophosphite), or sulphur-containing inorganic salts such as sodium sulphite.

Possible shell polymers for anionic core polymers are cationic polymers which can lose their cationic charge through a chemical reaction. Possible cationic monomers for this embodiment are ester quats, for example [2-(acryloyloxy)ethyl]trimethylammonium salts, [2-(methacryloyloxy)ethyl]trimethylammonium salts, dimethylaminoethyl methacrylate quaternized with diethyl sulphate or dimethyl sulphate, diethylaminoethyl acrylate quaternized with methyl chloride. In this case, the chemical reaction which leads to retarded swelling of the SAP is an ester hydrolysis. A neutralization reaction of the shell polymer is possible with the following polymers: poly-3-dimethylaminopropylacrylamide, poly-3-dimethylaminopropylmethacrylamide, polyallylamine, polyvinylamine, polyethyleneimine. All polymers are used here in the form of salts. For the neutralization of the amino function, inorganic or organic acids can be used, and their mixed salts are also suitable. All variants mentioned are encompassed by the present invention.

For the establishment of the kinetics of the detachment reaction which are appropriate for the application, it may be necessary to incorporate further nonionic monomers into the cationic shell polymer. It is possible to use all nonionic monomers already mentioned under process variant a).

This variant c) of the invention is not just restricted to one-layer shells. In order to achieve a further or more exact time delay, it is possible, after the first shell layer which has been applied directly to the core polymer, to apply a second with the same charge that the core polymer also originally possesses. This can be continued further, in which case the charges of the shell polymers alternate. An anionic core polymer would be followed after the first cationic shell by an anionic second shell. The third shell would then be cationic again. Irrespective of the number of different shell layers, one or more shell layer(s) may be crosslinked. Moreover, preferably at least one shell layer should have been crosslinked with the aid of an aqueous solution.

Moreover, the present invention takes account of the possibility that the shell polymer in process variant c), per layer applied, was used in an amount of 5 to 100% by weight, preferably of 10 to 80% by weight and more preferably in an amount of 25 to 75% by weight, based in each case on the core polymer.

A further variation of the invention relates to the crosslinking of the shell polymer and the control of its detachment rate. To this end, it is possible, for example, to use free amino groups of the shell polymers. The crosslinker is added later than the shell polymer, preferably as an aqueous solution. In order to ensure full reaction of the crosslinker, it may be necessary to heat the retarded superabsorbent polymer once again after drying, or to perform the drying at elevated temperature. Possible crosslinkers for this form of the procedure are diepoxides such as diethylene glycol diglycidyl ether or polyethylene glycol diglycidyl ether, diisocyanates (which have to be applied in anhydrous form after the drying), glyoxal, glyoxylic acid, formaldehyde, formaldehyde formers and suitable mixtures.

In order to control the kinetics of the detachment operation, the composition of the shell polymer should be adjusted to the core polymer. This can be done, for example, by determining the appropriate composition. It has been found to be favourable to establish identical molar ratios in the core polymer and in the shell polymer; however, the charges must be different. According to the application, however, deviations from the molar ratios may also be found to be positive.

The optimal amount of shell polymer likewise has to be determined. Generally, it can be stated that finely structured core polymers require larger amounts of shell polymer, since they possess a greater surface area. The molecular weight of the shell polymers may also play a role, since short-chain shell polymers become detached more readily.

The process of surface coating c) requires more process steps than the two alternative steps a) and b). In principle, it is also conceivable to perform the core polymer synthesis as an inverse suspension polymerization and, after the drying by azeotropic distillation, to supply a new monomer solution which corresponds to that of the shell polymer. Were this to be surface polymerized, process step c) would be reduced to a one-pot reaction. However, the residence time in the reactor would be quite long and it is not easy to form a homogeneous layer of the shell polymer only at the surface.

Variant d: Combination of a Hydrolysis-Stable Monomer with a Hydrolysis-Labile Monomer in the Presence of a Crosslinker

The further process variant d) of the invention relates to an SAP which, after the polymerization, is composed of at least two nonionic comonomers but contains not more than 5 mol % of anionic or cationic charge. Among these nonionic comonomers is at least one which can be converted by a chemical reaction, preferably a hydrolysis, to an ionic monomer. The remainder consists of permanently nonionic monomers which are not subject to any significant hydrolysis even in the case of prolonged treatment of the SAP at high pH. This monomer which is then ionic gives rise to an osmotic pressure which leads to greater swelling of the SAP. An example given is that of an SAP which consists of acrylamide and hydroxypropyl acrylate (HPA), and also a crosslinker. When this SAP is exposed to an alkaline medium, an ester hydrolysis of the HPA occurs, which leads to acrylate units. This gives rise to an additional osmotic pressure and the SAP swells further. In this embodiment, it should be noted that purely nonionic SAP also has a certain “natural” swelling (entropy effect, comparable to an EPDM rubber in petroleum); there is therefore not zero swelling here in the initial state.

The polymerization is performed as already described in embodiment a).

Suitable hydrolysis-stable monomers are preferably permanently nonionic monomers which are preferably selected from the group of the water-soluble acrylamide derivatives, preferably alkyl-substituted acrylamides or aminoalkyl-substituted derivatives of acrylamide or of methacrylamide, and more preferably acrylamide, methacrylamide, N-methylacrylamide, N-methylmethacrylamide, N,N-dimethylacrylamide, N-ethylacrylamide, N,N-diethylacrylamide, N-cyclohexylacrylamide, N-benzylacrylamide, N,N-dimethylaminopropylacrylamide, N,N-dimethylaminoethylacrylamide, N-tert-butylacrylamide, N-vinylformamide, N-vinylacetamide, acrylonitrile, methacrylonitrile, or any mixtures thereof.

Suitable hydrolysable monomers are selected from nonionic monomers, for example water-soluble or water-dispersible esters of acrylic acid or methacrylic acid, such as hydroxyethyl (meth)acrylate, hydroxypropyl (meth)acrylate (as a technical grade product, an isomer mixture), esters of acrylic acid and methacrylic acid which possess, as a side chain, polyethylene glycol, polypropylene glycol or copolymers of ethylene glycol and propylene glycol, and ethyl (meth)acrylate, methyl (meth)acrylate, 2-ethylhexyl acrylate.

In addition, it is possible to use amino esters of acrylic or methacrylic acid, since these too are deprotonated very rapidly in cementitious systems (high pH) and hence are present in neutral form. Possible monomers of this type are dimethylaminoethyl (meth)acrylate, tert-butylaminoethyl methacrylate or diethylaminoethyl acrylate. Useful crosslinkers include especially all hydrolysis-stable and hydrolysis-labile representatives already specified in connection with process variant a), which can also be used in this case a) in the proportions specified there in each case.

In the case of variant d), the pure embodiment shall be understood to be that in which exclusively hydrolysis-stable crosslinkers are used.

### MIXED EMBODIMENTS

Finally, the invention includes any desired combinations of the four process variants a), b), c) and d): in many cases, it is advisable to combine the different variants (a+b+c+d; a+b+c; a+b+d; b+c+d; a+c+d; a+b; a+c; a+d; b+d; c+d). One possibility for this purpose is in particular the step of gel polymerization or inverse suspension polymerization. A further aspect of the present invention can therefore be considered to be that of an SAP which was prepared with the aid of at least two process variants a), b), c) and d), and preferably employing gel polymerization and/or an inverse suspension polymerization. It is easily also possible for a hydrolysis-labile crosslinker to be introduced into a monomer solution composed of an anionic monomer and a cationic, hydrolysable monomer, in addition to the hydrolysis-stable crosslinker. When such a polymer is used as a core polymer for the surface coating, the three variants a), b) and c) are implemented in the preparation of the inventive SAP.

Among all embodiments, variants a), b) and c), and the combination of variants a), b) and d), are preferred, since they need only one process step (gel polymerization or inverse suspension polymerization), while embodiments which make use of variant c) require three process steps (synthesis of the core polymer, synthesis of the shell polymer, surface coating) or lead to prolonged residence times in the reactor.

In addition to the superabsorbent polymer and the four process variants a), b), c) and/or d) for the preparation thereof, the present invention also encompasses the use of the SAP.

Preference is given to using the inventive superabsorbent polymers in foams, mouldings, fibres, foils, films, cables, sealing materials, coatings, carriers for plant growth- and fungal growth-regulating agents, packaging materials, soil additives for controlled release of active ingredients or in building materials, the main emphasis of the present invention being on use in construction materials and corresponding mixtures. The present invention therefore takes account especially of the use of the SAP as an additive to dry mortar mixtures, to concrete mixtures, to high-build coatings with a layer thickness of 0.5 to 2 cm and especially between 1 and 1.5 cm, all of said mixtures and coatings preferably being based on cement and more preferably comprising bitumen. Also included is the preferred use for polymer dispersions which find use in the construction sector. Particular mention should be made here of redispersible dispersion powders.

Use in hygiene articles is of only minor significance owing to the retarded swelling.

A further aspect of use relates to the retarded swelling, which has already been described in detail, of the inventive SAP. The present invention therefore includes a specific use in which, 30 min after preparation of the construction chemical mixture including the inventive SAP, not more than 70%, preferably not more than 60% and more preferably not more than 50% of the maximum absorption capacity of the superabsorbent polymer has been attained, In the context of the present invention, this maximum absorption capacity is determined in an aqueous salt solution which comprises 4.0 g of sodium hydroxide or 56.0 g of sodium chloride per litre of water.

Overall, it can be stated in summary that the main subject of the present invention consists in a superabsorbent polymer which is defined by specific preparation processes and combinations thereof and which is notable especially for a retarded swelling action with a commencement of swelling no earlier than after 5 minutes, especially in construction applications. The swelling behaviour differs from that of the superabsorbent polymers known to date principally in that liquid absorption occurs with a time delay in the region of minutes as a result of the specific structure of the SAP. This contrasts with the applications known to date in the hygiene sector, where a specific value is placed on the fact that (body) fluids are absorbed completely by the polymer within a very short time. As a result of the retarded swelling and absorptive action of the inventive superabsorbent polymers, the setting and hardening behaviour can be controlled with respect to time especially in construction chemical materials, and the amount of mixing water required can be adjusted to the particular specific application. In addition, however, it is also possible to use the inventive SAPs in so-called composite units. Such a composite comprises the inventive SAP and a specific substrate. The SAP and the substrate are bonded to one another in a fixed manner. Films made of polymers, for example made of polyethylene, polypropylene or polyamide, but also metals, nonwovens, fluffs, tissues, wovens, natural or synthetic fibres or else foams, are suitable substrates. Such a composite comprises the inventive SAP in an amount of approx. 15 to 100% by weight, preference being given to amounts between 30 and 99% by weight and especially to those between 50 and 98% by weight (based in each case on the total weight of the composite).

Owing to the retarded absorption capacity, the inventive SAPs are, of course, suitable only to a limited degree for use in hygiene articles and especially towels and nappies, and this end use is therefore not within the actual focus of the present invention.

The examples which follow illustrate the advantages of the present invention, without restricting it thereto.

### EXAMPLES

### Abbreviations

AcOH=acrylic acid
AcA=acrylamide
Na-AMPS=2-acrylamido-2-methylpropanesulphonic acid sodium salt
DEGDA=diethylene glycol diacrylate
MbA=N,N′-methylenebisacrylamide
MADAME-Quat=[2-(methacryloyloxy)ethyl]trimethylammonium chloride
DIMAPA-Quat=[3-(acryloylamino)propyl]trimethylammonium chloride
DIMAPA=dimethylaminopropylacrylamide
TEPA=tetraethylenepentamine
HPA=hydroxypropyl acrylate (isomer mixture)

### 1. Preparation Examples

### 1.1 Process Variant a):

Polymer 1-1: Copolymer of Na-AMPS and AcA crosslinked with MbA and DEGDA

A 2 l three-neck flask with stirrer and thermometer was initially charged with 141.8 g of water to which were then added successively 352.50 g (0.74 mol, 27 mol %) of Na-AMPS (50% by weight solution in water), 286.40 g (2.0 mol, 70 mol %) of AcA (50% by weight solution in water), 18.20 g of 75% DEGDA (0.064 mol, 2.9 mol %) and 0.3 g (0.0021 mol, 0.08 mol %) of MbA. After adjustment to pH 7 with a 20% sodium hydroxide solution and purging with nitrogen for 30 minutes, the mixture was cooled to approx. 5° C. The solution was transferred to a plastic vessel with dimensions (w·d·h) 15 cm·10 cm·20 cm to which were then added successively 16 g of a 1% 2,2′-azobis(2-amidinopropane) dihydrochloride solution, 20 g of a 1% sodium peroxodisuiphate solution, 0.7 g of a 1% Rongalit C solution, 16.2 g of a 0.1% tert-butyl hydroperoxide solution and 2.5 g of 0.1% iron(II) sulphate heptahydrate solution. The copolymerization was started by irradiating with UV light (two Philips tubes; Cleo Performance 40 W). After approx. two hours, the hardened gel was removed from the plastic vessel and cut into cubes of edge length approx. 5 cm with scissors. Before the gel cubes were comminuted with a conventional meat grinder, they were painted with the separating agent Sitren 595 (polydimethylsiloxane emulsion; from Goldschmidt). The separating agent was a polydimethylsiloxane emulsion which had been diluted with water in a ratio of 1:20.

The resulting gel granule of Polymer 1-1 was distributed homogeneously on drying grids and dried to constant weight in a forced-air drying cabinet at approx. 100 to 120° C. Approx. 300 g of a white, hard granule were obtained, which were converted to a pulverulent state with the aid of a centrifugal mill. The mean particle diameter of the polymer powder was 30 to 50 μm and the proportion of particles which do not pass through a screen of mesh size 63 μm was less than 2% by weight.

### 1.2 Process Variant b):

Polymer 2-1 (with a hydrolysis-stable crosslinker): copolymer of Na-AMPS and MADAME-Quat crosslinked with MbA
A 2 l three-neck flask with stirrer and thermometer was initially charged with 82.6 g of water to which were then added successively 488.64 g (1.07 mol, 49.9 mol %) of Na-AMPS (50% by weight solution in water), 295.3 g (1.07 mol, 49.9 mol %) of MADAME-Quat (75% by weight solution in water) and 0.9 g (0.0063 mol, 0.1 mol %) of MbA.

After adjustment to pH 4 with 20% sulphuric acid and purging with nitrogen for thirty minutes, the mixture was cooled to approx. 10° C. The solution was transferred to a plastic vessel with dimensions (w d h) 15 cm·10 cm·20 cm. The polymerization and the workup were effected using the same initiator system as that described under Polymer 1-1.

Approx. 430 g of a white, hard granule were obtained, which were converted to a pulverulent state with the aid of a centrifugal mill. The mean particle diameter of the polymer powder was 30 to 50 μm and the proportion of particles which do not pass through a screen of mesh size 63 μm was less than 2% by weight.
Polymer 2-2 (with a hydrolysis-stable crosslinker and a hydrolysis-labile crosslinker): copolymer of Na-AMPS and MADAME-Quat crosslinked with MbA and DEGDA

A 2 l three-neck flask with stirrer and thermometer was initially charged with 79.3 g of water to which were then added successively 488.64 g (1.07 mol, 48.5 mol %) of Na-AMPS (50% by weight solution in water), 260.4 g (1.07 mol, 48.5 mol %) of MADAME-Quat (75% by weight solution in water), 0.9 g (0.0063 mol, 0.3 mol %) of MbA and 18.20 g of 75% of DEGDA (0.064 mol, 2.9 mol %).

After adjustment to pH 4 with 20% sulphuric acid and purging with nitrogen for thirty minutes, the mixture was cooled to approx. 10° C. The polymerization and workup were effected using the same initiator system as that described under Polymer 1-1.

Approx. 430 g of a white, hard granule were obtained, which were converted to a pulverulent state with the aid of a centrifugal mill. The mean particle diameter of the polymer powder was 30 to 50 μm and the proportion of particles which do not pass through a screen of mesh size 63 μm was less than 2% by weight.

### 1.3 Process Variant c):

### Core Polymers:

Anionic core polymer of AcA and Na-AMPS crosslinked with MbA (C1a)

A 2 l three-neck flask with stirrer and thermometer was initially charged with 160 g of water to which were then added successively 352.50 g (0.74 mol, 28 mol %) of Na-AMPS (50% by weight solution in water), 286.40 g (2.0 mol, 72 mol %) of AcA (50% by weight solution in water) and 0.3 g (0.0021 mol, 0.08 mol %) of MbA. After adjustment to pH 7 with a 20% sodium hydroxide solution and purging with nitrogen for thirty minutes, the mixture was cooled to approx. 5° C. The polymerization and workup were effected using the same initiator system as that described under Polymer 1-1.

Approx. 300 g of a white, hard granule were obtained, which were converted to a pulverulent state with the aid of a centrifugal mill. The mean particle diameter of the polymer powder was 30 to 50 μm and the proportion of particles which do not pass through a screen of mesh size 63 μm was less than 2% by weight.
Anionic core polymer of AcA and sodium acrylate crosslinked with MbA (C2a)

A 2 l three-neck flask with stirrer and thermometer was initially charged with 300 g of water to which were then added successively 84.80 g of a 50% sodium hydroxide solution (1.06 mol), 126.4 g of AcOH (1.75 mol), 300.00 g of a 50% AcA solution (2.11 mol) and 0.8 g of MbA (0.0056 mol). After purging with nitrogen for thirty minutes, the mixture was cooled to approx. 5° C. The polymerization and workup were effected using the same initiator system as that described under Polymer 1-1.

Approx. 300 g of a white, hard granule were obtained, which were converted to a pulverulent state with the aid of a centrifugal mill. The mean particle diameter of the polymer powder was 30 to 50 μm and the proportion of particles which do not pass through a screen of mesh size 63 μm was less than 2% by weight.
Cationic Core Polymer of Aca and DIMAPA-Quat Crosslinked with Mba (C3c)

A 2 l three-neck flask with stirrer and thermometer was initially charged with 276.5 g of water. Subsequently, 246.90 g (0.72 mol, 27 mol %) of DIMAPA-Quat (60% by weight solution in water), 262.60 g (1.84 mol, 73 mol %) of AcA (50% by weight solution in water) and 0.3 g (0.0021 mol, 0.08 mol %) of MbA were added successively. After adjustment to pH 7 with 20% sodium hydroxide solution and purging with nitrogen for thirty minutes, the mixture was cooled to approx. 5° C. The polymerization and workup were effected using the same initiator system as that described under Polymer 1-1.

Approx. 260 g of a white, hard granule were obtained, which were converted to a pulverulent state with the aid of a centrifugal mill. The mean particle diameter of the polymer powder was 30 to 50 μm and the proportion of particles which do not pass through a screen of mesh size 63 μm was less than 2% by weight.
Cationic shell polymer of AcA and DIMAPA hydrochloride (S1c)

A 10 l jacketed reactor was initially charged with 4500 kg of demineralized water. Then 416.80 g (2.67 mol, 32.1 mol %) of DIMAPA and 801.60 g (5.63 mol, 67.9 mol %) of AcA (50% by weight solution in water) were added and neutralized rapidly with 367.25 g of a 25% hydrochloric acid solution, so as to establish a pH of 5. Subsequently, the mixture was made up with 1819 g of water to 7904.8 g (so as to give 8000 g after initiation) and purged with nitrogen for 30 min. In the course of nitrogen purging, the mixture was heated to 70° C. with a thermostat. The polymerization was started by adding 15.2 g of a 20% aqueous TEPA solution and 80.0 g of a 20% aqueous sodium peroxodisulphate solution. The mixture was stirred at thermostat temperature 70° C. for a further 2 h, allowed to cool and transferred.

At room temperature, the product possessed a viscosity of 2000 mPas (Brookfield, 10 rpm).
Anionic shell polymer of AcA and sodium acrylate (S2a)

A 10 l jacketed reactor was initially charged with 6055 g of water. After the addition of 176.8 g (4.42 mol) of sodium hydroxide (solid), 383.20 g (5.31 mol, 45.4 mol %) of AcOH and 912 g (6.40 mol, 54.6 mol %) of AcA (50% by weight solution in water) were added with cooling. A little 20% sulphuric acid was used to adjust the pH to 5.0 and then the mixture was purged with nitrogen for 30 min. In the course of nitrogen purging, the mixture was heated to 70° C. with a thermostat. The polymerization was started by adding 15.2 g of a 20% aqueous TEPA solution and 80.0 g of 20 percent aqueous sodium peroxodisulphate solution. The mixture was stirred at thermostat temperature 70° C. for a further 2 h, allowed to cool and transferred, The viscosity was 15 mPas (Brookfield, 10 rpm).
Polymer 3-1: Coating of an anionic superabsorbent polymer (C1a) with a cationic shell polymer S1c (copolymer of Na-AMPS, AcA and MbA is coated with a shell polymer of AcA and DIMAPA hydrochloride)

A 2 l jacketed reactor was initially charged with 1000 g of cyclohexane. After the addition of 6.0 g of Span® 60 protective colloid, 100 g of core polymer C1a were added and suspended. After heating to 70° C., 250 g of shell polymer solution S1c were slowly added dropwise and the temperature was increased to such an extent that the water added was removable by azeotropic distillation. As the azeotrope temperature reached 72° C., the mixture was cooled below the boiling point. After the slow addition of a further 250 g of shell polymer solution S1c, the mixture was heated again to boiling and water was separated out until the azeotrope temperature was 75° C.

After cooling, the solid was filtered off and washed with a little ethanol.
Polymer 3-2: Coating of an anionic superabsorbent polymer (C2a) with a cationic shell polymer S1c (copolymer of sodium acrylate, AcA and MbA is coated with a shell polymer of AcA and DIMAPA hydrochloride)

The procedure here was analogous to that for Polymer Example 3-1, except that the same amount of core polymer C2a was initially charged instead of core polymer C1a.
Polymer 3-3: Coating of a cationic superabsorbent polymer (C3c) with an anionic shell polymer S2a (copolymer of DIMAPA-Quat, AcA and MbA is coated with a shell polymer of AcA and sodium acrylate)

The procedure here was analogous to Example 3-1, except that the same amount of core polymer C3c was initially charged instead of core polymer C1a. The shell polymer used was shell polymer S2a. Addition, azeotropic distillation and filtration were effected as described above.
Polymer 3-4: Coating of a cationic superabsorbent polymer (C3c) with an anionic shell polymer S2a with addition of a crosslinker for the shell polymer (copolymer of DIMAPA-Quat, AcA and MbA is coated with a shell polymer of AcA and sodium acrylate and crosslinked with glyoxylic acid)

The shell polymer was applied here as described under 3-3. In the second azeotropic distillation, on attainment of azeotrope temperature 75° C., the reactor temperature was reduced to 50° C. At internal temperature 50° C., 2.5 g of 50% aqueous glyoxylic acid were added. The product was filtered off and heat treated at 120° C. for 2 h.
Polymer 3-5: Coating of an anionic core polymer based on Na-AMPS(C1a) with a three-layer cationic/anionic/cationic shell S1c/S2a/S1c

A 2 l jacketed reactor was initially charged with 1000 g of cyclohexane. After the addition of 6.0 g of Span® 60 protective colloid, 100 g of core polymer C1a were added and suspended. After heating to 70° C., 250 g of shell polymer solution S1c were slowly added dropwise and the temperature was increased to such an extent that the water added was removable by azeotropic distillation. As the azeotrope temperature reached 72° C., the mixture was cooled below the boiling point. After the slow addition of 250 g of shell polymer solution S2a, the mixture was heated again to boiling and water was separated out until the azeotrope temperature was again 72° C.; the mixture was then cooled again and a further 250 g of shell polymer solution S1c were added. Water was then removed azeotropically until the temperature was again 75° C. After cooling, the solid was filtered off and washed with a little ethanol.
Polymer 3-6: Coating of an anionic core polymer based on sodium acrylate/AcA (C1a) with a three-layer cationic/anionic/cationic shell S1c/S2a/S1c

Polymer 3-6 was prepared like Polymer 3-5 with the difference that 100 g of core polymer C2a were used.
Polymer 4-1 Copolymer of AcA and HPA crosslinked with pentaerythritol triallyl ether

A 2 l three-neck flask with stirrer and thermometer was initially charged with 82.6 g of water to which were then added successively 160 g (1.18 mol, 45.4 mol %) of HPA (96%), 204.20 g (1.42 mol, 54.5 mol %) of AcA (50% by weight solution in water) and 0.72 g (0.003 mol, 0.1 mol %) of pentaerythritol triallyl ether (approx. 70 percent).

This established a pH of 5. While purging with nitrogen for thirty minutes, the mixture was cooled to approx. 10° C. The solution was transferred to a plastic vessel with dimensions (w·d·h) 15 cm ˜10 cm·20 cm. The polymerization and the workup were effected using the same initiator system as that described under Polymer 1-1.

Approx. 285 g of a white, hard granule were obtained, which were converted to a pulverulent state with the aid of a centrifugal mill. The mean particle diameter of the polymer powder was 30 to 50 μm and the proportion of particles which do not pass through a screen of mesh size 63 μm was less than 2% by weight.

### 2. Application Examples

### 2.1 Time-Dependent Swelling Test

### Composition of the Test Solution

4 g of solid sodium hydroxide and 56 g of sodium chloride were dissolved in 996 g of demineralized water.

200 ml of the test solution were initially charged in a 400 ml beaker and admixed with 2.00 g of the particular inventive polymer and stirred briefly with a glass rod. After 30 min (without stirring), the mixture was filtered through a 100 μm sieve (30 min value).

For the determination of the final value, the test was repeated with a measurement time of 24 h.

| | Absorption in NaOH in g/g of product | | Proportion after |
|---|---|---|---|
| Product | 30 min | Final value (24 h) | 30 min in % |
| Polymer 1-1 | 13 | 22 | 60 |
| Polymer 2-1 | 9 | 22 | 40 |
| Polymer 2-2 | 6 | 20 | 30 |
| Polymer 3-1 | 12 | 21 | 60 |
| Polymer 3-2 | 14 | 22 | 70 |
| Polymer 3-3 | 9 | 18 | 50 |
| Polymer 3-4 | 7.5 | 16 | 45 |
| Polymer 3-5 | 5 | 14 | 35 |
| Polymer 3-6 | 6 | 15 | 40 |
| Polymer 4-1 | 15 | 32 | 50 |

### 2.2 Construction Applications

As can be seen by the following time-dependent mortar tests (slump), the hydrolysis proceeds more slowly in a construction material since
the excess of water is lower,
the opposing pressure against which the superabsorbent polymer has to swell is higher,
additives which prevent contact with water are present.

Therefore, all retarded superabsorbent polymers which, after 30 min, possess less than 70% swelling by the test outlined above are subjected to the time-dependent mortar test.

### Time-Dependent Slump

### Test Procedure

The time-dependent slump was determined using a standard mortar as described in DIN EN 196-1. To this end, 1350 g of standard sand, 450 g of Milke CEM I 52,5 R, 0.9 g of retarded superabsorbent polymer according to the invention and 225 g of water were mixed according to the standard. The slump was determined according to DIN EN 1015-3. Subsequently, the slump over time was determined. As a comparison, the slump was determined once without addition of retarded superabsorbent polymer.

TABLE 1
Comparison of the slumps

| | 5 | 15 | 30 | 45 | 60 |
|---|---|---|---|---|---|
| | min | min | min | min | min |
| Comparison | 20.4 | 20.4 | 20.2 | 20.0 | 19.8 |
| (without superabsorbent polymer) | | | | | |
| Polymer 1 | 20 | 20 | 19.5 | 18 | 16.5 |
| (AMPS/AcA/MbA/DEGDA) | | | | | |
| Polymer 2-1 | 20.1 | 19.8 | 19.0 | 18.0 | 16.5 |
| (AMPS/MADAME-Q/MbA) | | | | | |
| Polymer 2-2 | 20 | 19.8 | 19.4 | 18.3 | 16.5 |
| (AMPS/MADAME-Q/MbA/ | | | | | |
| DEGDA) | | | | | |
| Polymer 3-1 | 20 | 19.3 | 18.3 | 17.5 | 16 |
| (core: AMPS/AcA/MbA; | | | | | |
| shell: AcA/DIMAPA-HCl) | | | | | |
| Polymer 3-2 | 19.8 | 19.5 | 18.8 | 17.9 | 16.9 |
| (core: NaOAc/AcA/MbA; | | | | | |
| shell: AcA/DIMAPA-HCl) | | | | | |
| Polymer 3-3 | 20.1 | 19.5 | 18.6 | 17.7 | 16.4 |
| (core: DIMAPA-Q/AcA/MbA; | | | | | |
| shell: AcA/NaOAc) | | | | | |
| Polymer 3-4 | 20 | 19.8 | 19.3 | 18.5 | 17.8 |
| (core: DIMAPA-Q/AcA/MbA; | | | | | |
| shell: AcA/NaOAc/glyoxylic acid) | | | | | |
| Polymer 3-5 | 20.1 | 19.8 | 19.4 | 18.5 | 17.2 |
| (core: AMPS/AcA/MbA; | | | | | |
| shell: | | | | | |
| 1.) AcA/DIMAPA-HCl | | | | | |
| 2.) AcA/NaOAc | | | | | |
| 3.) AcA/DIMAPA-HCl) | | | | | |
| Polymer 3-6 | 20.2 | 19.9 | 19.4 | 18.2 | 17.1 |
| (core: NaOAc/AcA/DiAM; | | | | | |
| shell: | | | | | |
| 1.) AcA/DIMAPA-HCl | | | | | |
| 2.) AcA/NaOAc | | | | | |
| 3.) AcA/DIMAPA-HCl) | | | | | |
| Polymer 4-1 | 20.4 | 20 | 19.1 | 18.0 | 16.8 |
| (AM/HPA/PETAE) | | | | | |

### 2.3 Self-Compacting Concrete

The self-compacting concretes were mixed in the laboratory with a 50 litre mechanical mixer. The efficiency of the mixer was 45%. In the mixing operation, first additives and substances of flour fineness were homogenized in the mixer for 10 seconds, before the mixing water, the plasticizer and the stabilizer were then added. The inventive superabsorbent polymer was metered in with the additives and substances of flour fineness. The mixing time was 4 minutes. Thereafter, the fresh concrete test (slump flow) was carried out and assessed. The consistency profile was observed over 120 minutes.

### Determination of the Slump Flows

To determine the free flow, an Abrams slump cone (internal diameter at the top 100 mm, internal diameter at the bottom 200 mm, height 300 mm) was used (slump flow=diameter of the concrete cake measured over two axes at right angles to one another and averaged, in cm). The determination of the slump flow was carried out four times per mixture, specifically at the times t=0.30, 60 and 90 minutes after the end of mixing, the mixture having been mixed again for 60 seconds with the concrete mixer before the particular flow determination. The composition of the self-compacting concrete can be taken from Table 2.

TABLE 2
Composition of the test mixture in kg/m³; water content 160 kg/m³.

| Component | Amount |
|---|---|
| Portland cement ¹⁾ | 290 |
| Sand (0-2 mm) | 814 |
| Gravel (2-8 mm) | 343 |
| Gravel (8-16 mm) | 517 |
| Fly ash | 215 |
| Glenium ACE 30 ²⁾ | 3.3 |
| Starvis ® 2006 ²⁾ | 0.29 |

¹⁾ CEM I 42,5 R
²⁾ Product of BASF Construction Polymers GmbH, Trostberg

The water content of the additives is subtracted from the total amount of mixing water.

Slump flows:

| Inventive | Slump flow | Slump flow | Slump flow | Slump flow |
|---|---|---|---|---|
| polymer | after 0 min | after 30 min | after 60 min | after 90 min |
| None | 74 cm | 72 cm | 72 cm | 71 cm |
| Polymer 1 | 74 cm | 72 cm | 56 cm | 49 cm |
| Polymer 2-1 | 72 cm | 71 cm | 48 cm | 42 cm |

1-46. (canceled)

47. A superabsorbent polymer with at least one of anionic or cationic properties and retarded swelling action, which has been prepared by polymerizing ethylenically unsaturated vinyl compounds, wherein its swelling begins not earlier than after 5 minutes and it has been prepared with the aid of at least one process variant selected from the group consisting of
a) polymerizing the monomer components in the presence of a combination consisting of at least one hydrolysis-stable crosslinker and at least one hydrolysis-labile crosslinker;
b) polymerizing at least one permanently anionic monomer and at least one hydrolysable cationic monomer;
c) coating a core polymer component with at least one further polyelectrolyte as a shell polymer; and
d) polymerizing at least one hydrolysis-stable monomer with at least one hydrolysis-labile monomer in the presence of at least one crosslinker.

48. A superabsorbent polymer according to claims 47, wherein the monomer units have been used in the form of free acids, in the form of salts, or in a mixed form thereof.

49. A superabsorbent polymer according to claim 48, wherein the acid constituents have been neutralized after the polymerization.

50. A superabsorbent polymer according to claim 49, where the acid constituents have been neutralized with sodium hydroxide, potassium hydroxide, calcium hydroxide, magnesium hydroxide, sodium carbonate, potassium carbonate, calcium carbonate, magnesium carbonate, ammonia, a primary, secondary or tertiary C₁₋₂₀-alkylamine, C₁₋₂₀-alkanolamine, C₅₋₈-cycloalkylamine or C₆₋₁₄-arylamine, wherein the amines may have branched or unbranched alkyl groups, or mixtures thereof.

51. A superabsorbent polymer according to claim 47, wherein the polymerization in process variants a) or b) has been performed as a free-radical bulk polymerization, solution polymerization, gel polymerization, emulsion polymerization, dispersion polymerization or suspension polymerization.

52. A superabsorbent polymer according to claim 51, wherein the polymerization has been performed in aqueous phase, in inverse emulsion (water-in-oil emulsion) or in inverse suspension (water-in-oil suspension).

53. A superabsorbent polymer according to claim 47, wherein the polymerization has been performed under adiabatic conditions, the reaction preferably having been started with a redox initiator or a photoinitiator.

54. A superabsorbent polymer according to claim 47, wherein the polymerization has been started at temperatures between −20° C. and +30° C.

55. A superabsorbent polymer according to claim 47, wherein the polymerization has been performed under atmospheric pressure and preferably without supplying heat.

56. A superabsorbent polymer according to claim 47, wherein the polymerization has been performed in the presence of at least one water-immiscible solvent, especially of an organic solvent selected from the group consisting of the linear aliphatic hydrocarbons, preferably n-pentane, n-hexane, n-heptane, or of the branched aliphatic hydrocarbons (isoparaffins), or of the cycloaliphatic hydrocarbons, preferably cyclohexane and decalin, or of the aromatic hydrocarbons, preferably benzene, toluene and xylene, or alcohols, ketones, carboxylic esters, nitro compounds, halogenated hydrocarbons, ethers, or mixtures thereof, and more preferably an organic solvent which forms azeotropic mixtures with water.

57. A superabsorbent polymer according to claim 47, wherein it comprises, as an ethylenically unsaturated vinyl compound, at least one member selected from the group consisting of the ethylenically unsaturated, water-soluble carboxylic acids and ethylenically unsaturated sulphonic acid monomers, and salts and derivatives thereof, and preferably acrylic acid, methacrylic acid, ethacrylic acid, α-chloroacrylic acid, α-cyanoacrylic acid, β-methylacrylic acid (crotonic acid), α-phenylacrylic acid, β-acryloyloxypropionic acid, sorbic acid, α-chlorosorbic acid, 2′-methylisocrotonic acid, cinnamic acid, p-chlorocinnamic acid, β-stearyl acid, itaconic acid, citraconic acid, mesaconic acid, glutaconic acid, aconitic acid, maleic acid, fumaric acid, tricarboxyethylene, maleic anhydride or any mixtures thereof.

58. A superabsorbent polymer according to claim 59, wherein it comprises, as the acryloyl- or methacryloylsulphonic acid, at least one member from the group of sulphoethyl acrylate, sulphoethyl methacrylate, sulphopropyl acrylate, sulphopropyl methacrylate, 2-hydroxy-3-methacryloyloxypropylsulphonic acid and 2-acrylamido-2-methylpropanesulphonic acid (AMPS).

59. A superabsorbent polymer according to claim 47, wherein it comprises, as the nonionic monomer, at least one member from the group of (meth)acrylamide and the water-soluble (meth)acrylamide derivatives, preferably alkyl-substituted acrylamides or aminoalkyl-substituted derivatives of acrylamide or of methacrylamide, and more preferably acrylamide, methacrylamide, N-methylacrylamide, N-methylmethacrylamide, N,N-dimethylacrylamide, N-ethylacrylamide, N,N-diethylacrylamide, N-cyclohexylacrylamide, N-benzylacrylamide, N,N-dimethyl-aminopropylacrylamide, N,N-dimethylaminoethylacrylamide, N-tert-butylacrylamide, and also N-vinylformamide, N-vinylacetamide, acrylonitrile, methacrylonitrile, or any mixtures thereof.

60. A superabsorbent polymer according to claim 47, wherein, in process variant a), the hydrolysis-stable crosslinker used has been at least one member selected from the group of N,N′-methylenebisacrylamide, N,N′-methylenebismethacrylamide or monomers having at least one maleimide group, preferably hexamethylenebismaleimide, monomers having more than one vinyl ether group, preferably ethylene glycol divinyl ether, triethylene glycol divinyl ether, cyclohexanediol divinyl ether, allylamino or allylammonium compounds having more than one allyl group, preferably triallylamine or a tetraallylammonium salt such as tetraallylammonium chloride, or allyl ethers having more than one allyl group, such as tetraallyloxyethane and pentaerythritol triallyl ether, or monomers having vinylaromatic groups, preferably divinylbenzene and triallyl isocyanurate, or diamines, triamines, tetramines or higher-functionality amines, preferably ethylenediamine and diethylenetriamine.

61. A superabsorbent polymer according to claim 47, wherein the hydrolysis-labile crosslinker used has been at least one member from the group of the di-, tri- or tetra(meth)acrylates, such as 1,4-butanediol diacrylate, 1,4-butanediol dimethacrylate, 1,3-butylene glycol diacrylate, 1,3-butylene glycol dimethacrylate, diethylene glycol diacrylate, diethylene glycol dimethacrylate, ethylene glycol dimethacrylate, ethoxylated bisphenol A diacrylate, ethoxylated bisphenol A dimethacrylate, ethylene glycol dimethacrylate, 1,6-hexanediol diacrylate, 1,6-hexanediol dimethacrylate, neopentyl glycol dimethacrylate, polyethylene glycol diacrylate, polyethylene glycol dimethacrylate, triethylene glycol diacrylate, triethylene glycol dimethacrylate, tripropylene glycol diacrylate, tetraethylene glycol diacrylate, tetraethylene glycol dimethacrylate, dipentaerythritol pentaacrylate, pentaerythritol tetraacrylate, pentaerythritol triacrylate, trimethylolpropane triacrylate, trimethylolpropane trimethacrylate, cyclopentadiene diacrylate, tris(2-hydroxyethyl) isocyanurate triacrylate or tris(2-hydroxyethyl) isocyanurate trimethacrylate, the monomers having more than one vinyl ester or allyl ester group with corresponding carboxylic acids, such as divinyl esters of polycarboxylic acids, diallyl esters of polycarboxylic acids, triallyl terephthalate, diallyl maleate, diallyl fumarate, trivinyl trimellitate, divinyl adipate or diallyl succinate, or at least one member of the compounds having at least one vinylic or allylic double bond and at least one epoxy group, such as glycidyl acrylate, allyl glycidyl ether, or the compounds having more than one epoxy group, such as ethylene glycol diglycidyl ether, diethylene glycol diglycidyl ether, polyethylene glycol diglycidyl ether, polypropylene glycol diglycidyl ether, or the compounds having at least one vinylic or allylic double bond and at least one (meth)acrylate group, such as polyethylene glycol monoallyl ether acrylate or polyethylene glycol monoallyl ether methacrylate.

62. A superabsorbent polymer according to claim 47, wherein, in process variant a), the hydrolysis-stable crosslinker has been used in amounts of 0.01 to 1.0 mol %, preferably of 0.03 to 0.7 mol % and more preferably of 0.05 to 0.5 mol %.

63. A superabsorbent polymer according to claim 47, wherein, in process variant a), the hydrolysis-labile crosslinker has been used in amounts of 0.1 to 10.0 mol %, preferably of 0.3 to 7.0 mol % and more preferably of 0.5 to 5.0 mol %.

64. A superabsorbent polymer according to claim 47, wherein, in process variant b), the anionic monomer used has been at least one member from the group of the ethylenically unsaturated water-soluble carboxylic acids and ethylenically unsaturated sulphonic acid monomers, and salts and derivatives thereof, especially acrylic acid, methacrylic acid, ethacrylic acid, α-chloroacrylic acid, α-cyanoacrylic acid, β-methylacrylic acid (crotonic acid), α-phenylacrylic acid, β-acryloyloxypropionic acid, sorbic acid, α-chlorosorbic acid, 2′-methylisocrotonic acid, cinnamic acid, p-chlorocinnamic acid, β-stearyl acid, itaconic acid, citraconic acid, mesacronic acid, glutaconic acid, aconitic acid, maleic acid, fumaric acid, tricarboxyethylene, and maleic anhydride, more preferably acrylic acid, methacrylic acid, aliphatic or aromatic vinylsulphonic acids, and especially preferably vinylsulphonic acid, allylsulphonic acid, vinyltoluenesulphonic acid, styrenesulphonic acid, acryloyl- and methacryloylsulphonic acids, and even more preferably sulphoethyl acrylate, sulphoethyl methacrylate, sulphopropyl acrylate, sulphopropyl methacrylate, 2-hydroxy-3-methacryloyloxypropylsulphonic acid and 2-acrylamido-2-methylpropanesulphonic acid (AMPS), or mixtures thereof.

65. A superabsorbent polymer according to claim 7, wherein, in process variant b), the cationic monomer used has been at least one member from the group of the polymerizable cationic esters of vinyl compounds whose cationic charge can be eliminated by hydrolysis, preferably [2-(acryloyloxy)ethyl]trimethylammonium salts and [2-(methacryloyloxy)ethyl]methylammonium salts, or monomers which are vinylically polymerizable and bear an amine function which can be protonated, preferably salts of 3-dimethylaminopropylacrylamide or 3-dimethylaminopropylmethacrylamide, and more preferably the hydrochloride and hydrosulphate thereof, or mixtures thereof.

66. A superabsorbent polymer according to claim 47, wherein, in process variant b), a molar ratio of anionic to cationic monomer of 0.3 to 2.0:1 was present.

67. A superabsorbent polymer according to claim 47, wherein process variant c) neutralized charges on the polymer surface.

68. A superabsorbent polymer according to claim 47, wherein, in process variant c), shell polymers with a molecular weight of ≦5 million gμmol.

69. A superabsorbent polymer according to claim 47, wherein, in process variant c), the further polyelectrolyte (shell polymer) was used as an aqueous solution having a viscosity of 200 to 7500 mPas.

70. A superabsorbent polymer according to claim 47, wherein, in process variant c), the further polyelectrolyte had a proportion of cationic monomer of ≧75 mol %.

71. A superabsorbent polymer according to claim 47, wherein, in process variant c), the core polymer had a proportion of ≦10% by weight of comonomers with opposite charge.

72. A superabsorbent polymer according to claim 47, wherein, in process variant c), a core polymer which contained exclusively hydrolysis-stable crosslinkers as crosslinkers was used.

73. A superabsorbent polymer according to claim 47, wherein, in process variant c), a cationic core polymer which has a permanent cationic charge, preferably a [3-(acryloylamino)propyl]trimethylammonium salt and [3-(meth-acryloylamino)propyl]trimethylammonium salt and more preferably salts of the halide or methosulphate type, or else diallyldimethylammonium chloride, or a mixture thereof, was used.

74. A superabsorbent polymer according to claim 47, wherein process variant c) is a powder coating or an electrically stable coating in suspension.

75. A superabsorbent polymer according to claim 47, wherein the shell polymers used in process variant c) have been prepared with the aid of a solution polymerization.

76. A superabsorbent polymer according to claim 47, wherein the shell polymer in process variant c) has been used, per layer applied, in an amount of 5 to 100% by weight, preferably of 10 to 80% by weight and more preferably in an amount of 25 to 75% by weight, based in each case on the core polymer.

78. A superabsorbent polymer according to claim 47, wherein, in process variant c), a shell polymer which contains, as the cationic monomer, at least one compound from the group of the ester quats, preferably a [2-(acryloyl-oxy)ethyl]trimethylammonium salt [2-(methacryloyloxy)ethyl]trimethylammonium salt or [2-(acryloyloxy)ethyl]diethylmethylammonium salt, which contains chloride, monomethylsulphate, monoethylsulphate or sulphate as the anion, or mixtures thereof, was used.

79. A superabsorbent polymer according to claim 47, wherein the shell polymer in process variant c) contains at least one of the monomers from the group of 3-dimethylaminopropylacrylamide, 3-dimethylaminopropylmethacrylamide, allylamine, vinylamine or ethyleneimine, the amino function being neutralized preferably between 0 and 100%.

80. A superabsorbent polymer according to claim 47, wherein it possesses, in process variant c), at least two shell layers, the charge of the successive layers each being different from the layer below.

81. A superabsorbent polymer according to claim 47, wherein, in process variant c), at least one shell layer is crosslinked.

82. A superabsorbent polymer according to claim 81, wherein it has, in process variant c), at least one shell layer which has been crosslinked with the aid of an aqueous solution.

83. A superabsorbent polymer according to either of claims 81, wherein, in process variant c), the at least one shell layer has been crosslinked with the aid of a compound selected from the group consisting of the diepoxides, preferably diethylene glycol diglycidyl ether, polyethylene glycol diglycidyl ether, anhydrous diisocyanates, glyoxal, glyoxylic acid, formaldehyde, formaldehyde formers or mixtures thereof.

84. A superabsorbent polymer according to claim 47, wherein, in process variant d), the hydrolysis-stable monomer used was been a permanently nonionic monomer selected from the group consisting of the water-soluble acrylamide derivatives, preferably alkyl-substituted acrylamides or aminoalkyl-substituted derivatives of acrylamide or of methacrylamide, and more preferably acrylamide, methacrylamide, N-methylacrylamide, N-methylmethacrylamide, N,N-dimethylacrylamide, N-ethylacrylamide, N,N-diethylacrylamide, N-cyclohexylacrylamide, N-benzylacrylamide, N,N-dimethylaminopropylacrylamide, N,N-dimethylaminoethylacrylamide, N-tert-butylacrylamide, and also N-vinylformamide, N-vinylacetamide, acrylonitrile, methacrylonitrile, or any mixtures thereof, and of the vinyllactams such as N-vinylpyrrolidone or N-vinylcaprolactam, and vinyl ethers such as methylpolyethylene glycol-(350 to 3000) monovinyl ether, or those which derive from hydroxybutyl vinyl ether, such as polyethylene glycol-(500 to 5000) vinyloxybutyl ether, polyethylene glycol-block-propylene glycol-(500 to 5000) vinyloxybutyl ether, or any mixtures thereof.

85. A superabsorbent polymer according to claim 47, wherein, in process variant d), the hydrolysis-labile monomer used has been a nonionic monomer selected from the group consisting of the water-soluble or water-dispersible esters of acrylic acid or methacrylic acid, such as hydroxyethyl (meth)acrylate, hydroxypropyl (meth)acrylate (as a technical grade product, an isomer mixture), esters of acrylic acid and methacrylic acid which possess, as a side chain, polyethylene glycol, polypropylene glycol or copolymers of ethylene glycol and propylene glycol, ethyl (meth)acrylate, methyl (meth)acrylate and 2-ethylhexyl acrylate.

86. A superabsorbent polymer according to claim 47, wherein the A superabsorbent polymer preparable in process variant d) is a nonionic monomer with a proportion of anionic charge of not more than 5.0 mol %.

87. A superabsorbent polymer according to claim 47, wherein the crosslinker used in process variant d) is a hydrolysis-stable crosslinker and is at least one member selected from the group consisting of N,N′-methylenebisacrylamide, N,N′-methylenebismethacrylamide or monomers having at least one maleinimide group, preferably hexamethylenebismaleinimide, monomers having more than one vinyl ether group, preferably ethylene glycol divinyl ether, triethylene glycoldivinyl ether, cyclohexanediol divinyl ether, allylamino or allylammonium compounds having more than one allyl group, preferably triallylamine or a tetraallylammonium salt such as tetraallylammonium chloride, or allyl ethers having more than one allyl group, such as tetraallyloxyethane and pentaerythritol triallyl ether, or monomers having vinylaromatic groups, preferably divinylbenzene and triallyl isocyanurate, or diamines, triamines, tetramines or higher-functionality amines.

88. A superabsorbent polymer according to claim 1 to 39, wherein, in process variant d), the hydrolysis-stable crosslinker has been used in amounts of 0.01 to 1.0 mol %, preferably of 0.03 to 0.7 mol % and more preferably of 0.05 to 0.5 mol %.

89. A superabsorbent polymer according to claim 47, prepared with the aid of at least two process variants a), b), c) or d) and preferably employing a gel polymerization or an inverse suspension polymerization.

90. A superabsorbent polymer according to claim 41, wherein process variants a) and b) have been combined.

91. A composition comprising the superabsorbent polymer of claim 47, wherein said composition is a foam, molding, fiber, foil, film, cable, sealing material, coating, carrier for plant growth- and fungal growth-regulating agent, packaging material, soil additive, for controlled release of an active ingredient or a construction material.

92. A composition comprising the superabsorbent polymer of claim 47, wherein said composition is a dry mortar mixture, a concrete mixture, a high-build coating or polymer dispersion.

93. The composition of claim 91, wherein 30 minutes after preparation of the chemical construction mixture, not more than 70% of the maximum absorption capacity of the superabsorbent polymer has been attained.

94. The composition of claim 91, wherein the maximum absorption capacity has been determined in an aqueous salt solution which comprised 4.0 g of sodium hydroxide or 56.0 g of sodium chloride per litre of water.

95. The composition of claim 92, wherein 30 minutes after preparation of the chemical construction mixture, not more than 70% of the maximum absorption capacity of the superabsorbent polymer has been attained.

96. The composition of claim 92, wherein the maximum absorption capacity has been determined in an aqueous salt solution which comprised 4.0 g of sodium hydroxide or 56.0 g of sodium chloride per litre of water.
